(19) United States
(12) Patent Application Publication
(10) Pub. No.: US 2024/0084056 A1
(43) Pub. Date: Mar. 14, 2024

(54) Polyolefin-Based Ionomers and Production Thereof

(71) Applicant: ExxonMobil Chemical Patents Inc., Baytown, TX (US)

(72) Inventors: Tzu-Pin Lin, Seabrook, TX (US); Carlos R. Lopez-Barron, Houston, TX (US); Avery R. Smith, Houston, TX (US); Brian J. Rohde, Houston, TX (US); Alex E. Carpenter, Austin, TX (US); Matthew W. Holtcamp, Huffman, TX (US); Jo Ann M. Canich, Houston, TX (US); John R. Hagadorn, Houston, TX (US)

(21) Appl. No.: 18/259,520

(22) PCT Filed: Dec. 8, 2021
(86) PCT No.: PCT/US2021/062335

§ 371 Date: Jun. 27, 2023

Related U.S. Application Data
(60) Provisional application No. 63/131,505, filed on Dec. 29, 2020.

(51) Int. Cl. C08F 210/02; C08F 8/44; C08F 210/06

(52) U.S. Cl. CPC C08F 210/02; C08F 8/44; C08F 210/06; C08F 2810/50

(57) ABSTRACT

Elastomeric polyolefin-based ionomers and methods for making same. The ionomers can include a copolymer comprising: C₂-C₆₀ α-olefin monomer units; optional C₂-C₆₀ α-olefin comonomer units different than the monomer units; optional diene units; and about 0.1 wt % to about 20 wt % metal alkenyl units, based on the weight of the copolymer, wherein the metal alkenyl units have the formula —R(A−)—, wherein R is an alkyl group containing 2 to 10 carbon atoms, and A− is an anionic group. The copolymer can further include one or more metal cations derived from the group consisting of alkali metals, alkaline earth metals, group 3-12 metals, group 13-16 metals, and combination(s) thereof. The ionomer has a glass transition temperature of −60° C. to 5° C., and a weight average (Mw) of 50 to 5,000 kg/mol.

### CROSS REFERENCE TO RELATED APPLICATIONS

This application is a National Phase Application to PCT Application Serial No. PCT/US2021/062335 filed Dec. 8, 2021, which claims priority from U.S. Provisional Application No. 63/131,505 filed Dec. 29, 2020, the disclosure of which is incorporated herein by reference.

### FIELD

The present disclosure relates to polyolefin-based ionomers and production of polyolefin-based ionomers. The present disclosure also relates to unsupported catalysts to make elastomeric polyolefin-based ionomers.

### BACKGROUND

Cross-linked rubbers are used in numerous industrial and consumer applications, such as for coatings, seals, tires, tubing, and roofing, among many others. Cross-linked rubbers can be composed of vulcanized natural rubbers, polybutadiene, styrene-butadiene copolymers, acrylonitrile-butadiene copolymers, polyisoprene, isoprene-isobutylene copolymers, ethylene-propylene rubber, ethylene propylene diene monomer (EPDM) rubber, silicone elastomers, fluoroelastomers, polyurethane elastomers, and nitrile rubbers, among others. Cross-linked rubbers can be advantageous for combining toughness, elasticity, and resistance to heat, chemicals, and other environmental factors. However, cross-linked rubbers also have important disadvantages. For instance, cross-linked rubbers cannot flow, even at elevated temperature, due to their relatively high cross-linking density. Furthermore, cross-linked rubbers cannot be reprocessed because their cross-linking is irreversible.

Thus, there is a need to develop alternatives to cross-linked rubbers that can flow and be reprocessed while also retaining the desirable properties of cross-linked rubbers, such as toughness, elasticity, and resistance to heat, chemicals, and other environmental exposure.

In addition, while cross-linked rubbers do have advantageous mechanical properties, such as the ability to elastically deform, these mechanical properties are dependent on their underlying polymer composition. For example, in the case of styrene-butadiene copolymers, elastic properties thereof worsen with increasing styrene content. Moreover, various properties of cross-linked rubbers can depend heavily on their specific degree of cross-linking. However, cross-linking can be problematic because cross-linked rubbers tend to allow only limited tuning of their degree of cross-linking, for example, in the case of EPDM rubber.

Thus, there is a need for polymer alternatives to cross-linked rubbers that can retain the mechanical properties of cross-linked rubbers, such as their ability to elastically deform, without the need to cross-link the polymer.

References for citing in an information disclosure statement under 37 C.F.R. 1.97(h): U.S. Pat. No. 8,329,848; WO Patent Publication Nos. 2017/013246; 2010/050437; 2019/122457; JP Patent Publication Nos. 2011/256256; 2007/262335; 2007/262631; 2007/262336; 2007/262330; 2007/262338; 2007/261211; 2007/254575; 2006/089542; 2003/246820; 2005/320420; Nam, Y. et al. (2002) “Propene Polymerization with Stereospecific Metallocene Dichloride—[Ph₃Cl][B(C₆F₅)₄] Using ω-Alkenylaluminum as an Alkylation Reagent and as a Functional Comonomer,” Macromolecules, v.35(18), pp. 6760-6762; Lee, J. et al. (2013) “Copolymerization of norbomene with ω-alkenylaluminum as a precursor comonomer for introduction of carbonyl moieties,” Journal of Polymer Science, Part A: Polymer Chemistry, V.51(23), pp. 5085-5090; Shiono, T. et al. (2013) “Facile Synthesis of Hydroxy-Functionalized Cycloolefin Copolymer Using ω-Alkenylaluminium as a Comonomer,” Macromol. Chem. Phys., 214(19), pp. 2239-2244; Kang, K. et al. (1998) “Preparations of Propylene and Ethylene Ionomers with Solvay-Type TiCL₃ Catalyst,” J.M.S.-Pure Appl. Chem., A35(6), pp. 1003-1016; Landoll, L. et al. (1989) “Polypropylene Ionomers,” Journal of Polymer Science: Part A: Polymer Chemistry, v.27, pp. 2189-2201.

### SUMMARY

Elastomeric polyolefin-based ionomers and methods for making same are provided. It has been discovered that the polyolefin-based ionomers provided herein can flow and can be reprocessed while retaining certain properties of cross-linked rubbers, including toughness, elasticity, as well as resistance to heat, chemicals, and other environmental exposure. The ionomer can include a copolymer comprising: C₂-C₆₀ α-olefin monomer units; optional C₂-C₆₀ α-olefin comonomer units different than the monomer units; optional diene units; and about 0.1 wt % to about 20 wt % metal alkenyl units, based on the weight of the copolymer, wherein the metal alkenyl units have the formula —R(A−)—, wherein R is an alkyl group containing 2 to 10 carbon atoms, and A− is an anionic group. The copolymer can further include one or more metal cations derived from the group consisting of alkali metals, alkaline earth metals, group 3-12 metals, group 13-16 metals, and combination(s) thereof. The ionomer has a glass transition temperature of −60 to 5° C., and a weight average (Mw) of 50 to 5,000 kg/mol.

### BRIEF DESCRIPTION OF THE DRAWINGS

So that the manner in which the above recited features of the present disclosure can be understood in detail, a more particular description of the disclosure, briefly summarized above, may be had by reference to embodiments. Certain aspects of some embodiments are illustrated in the appended figures. It is to be noted, however, that the appended figures illustrate only exemplary embodiments, and therefore are not to be considered limiting of scope, and may admit to other equally effective embodiments.

FIG. 1 is a graph illustrating an FTIR analysis comparison between the ethylene-propylene-AVTA-K ionomer (Example 1), an ethylene-propylene copolymer (Control 1), and a potassium acetate standard, according to at least one embodiment provided herein.

FIG. 2A shows stress-strain curves of the two samples (Example 1 and Control 1) measured at 25° C., according to at least one embodiment provided herein.

FIG. 2B is a graph illustrating a hysteresis test of the ethylene-propylene-AVTA-K ionomer (Example 1) experimental sample measured at 25° C., according to at least one embodiment provided herein.

FIG. 3 is a graph illustrating a comparison of scattering data between the ethylene-propylene-AVTA-K ionomer (Example 1) and the ethylene-propylene copolymer (Control 1) experimental samples, according to at least one embodiment provided herein.

FIG. 4 shows the DMTA analysis of the ethylene-propylene-AVTA-K ionomer (Example 2) and the ethylene-propylene copolymer (Control 2) experimental samples, according to at least one embodiment provided herein.

FIGS. 5A, 5B, 5C, 5D, and 5E show thirty-two (32) illustrative catalyst complexes that are represented by Formula (A).

### DETAILED DESCRIPTION

The present disclosure generally relates to polyolefin-based ionomers and production of polyolefin-based ionomers. It has been discovered that compared to nonpolar polyolefins, polyolefins featuring polar ionic groups can have unique and improved properties, such as improved adhesion and printability. Some types of polar polyolefins can also provide advanced functionality including for use in fuels, batteries, and sensor materials. Polyolefin-based ionomers (ionomeric polyolefins) are produced from polymers or copolymers (polymer precursors) including, for example, polyethylene, polypropylene, or copolymers of ethylene and propylene.

Polyolefin-based ionomers can be difficult to produce because heteroatom-containing ionic groups, such as hydroxyl or carboxylic acid groups, can inhibit catalyst(s) used to form the polymer precursors (of the ionomers). A heteroatom is an atom other than carbon or hydrogen. In that regard, transition metal catalysts (e.g., titanium and zirconium metallocenes) may be used for polymerizing nonpolar olefins because of their propensity for forming polyolefins having high molecular weight and high functional monomer content. However, the transition metal catalysts are readily poisoned by heteroatoms. Some polyolefin catalysts are deactivated by nucleophilic heteroatoms, making ionomeric polyolefin synthesis challenging. A method for producing polyolefin-based ionomers that avoids interaction between heteroatom-containing ionic groups and metal catalysts is provided. Such method includes vinyl-addition copolymerization techniques.

Suitable polyolefin-based polymer precursors can include olefin comonomer units and metal alkenyl comonomer units, such as aluminum vinyl. In some aspects, the metal alkenyl units can be or can include aluminum vinyl (AV), such as di(isobutyl)(7-octen-1-yl)aluminum (AVTA-1/8). In at least some aspects, the metal alkenyl units can be used to produce polyolefins having pendant metal groups, such as pendant aluminum groups. Thereafter, the pendant metal groups can be converted to ionic groups via oxidation. Thereafter, the polyolefin-based polymer precursors can undergo ion exchange with metal ions to form a polyolefin-based ionomer.

It has been discovered that polyolefin-based ionomers can have improved mechanical properties, such as toughness and elasticity, compared with their precursor copolymers without ionic groups. It has been further discovered that polyolefin-based ionomers can flow and can be reprocessed while also retaining one or more properties of cross-linked rubbers, such as toughness, elasticity, and resistance to heat, chemicals, and other environmental exposure. In some embodiments, the polyolefin-based ionomers, in contrast to their precursor polymers, can behave similarly to physically cross-linked materials, such as cross-linked rubbers, at room temperature and can be reprocessed into new products at relatively higher temperatures. In some embodiments, the polyolefin-based ionomers can perform as well or better than soft grade ethylene propylene rubbers.

The term “and/or” refers to both the inclusive “and” case and the exclusive “or” case, and such terms are used herein for brevity. For example, a composition comprising “A and/or B” may comprise A alone, B alone, or both A and B; and a composition comprising “A and or B” may comprise A alone, or both A and B.

The percentage of a particular monomer in a polymer is expressed herein as weight percent (wt %) based on the total weight of the polymer present. Other percentages are expressed as weight percent (wt %), based on the total weight of the particular composition present, unless otherwise noted. Room temperature is 25° C.±2° C. and atmospheric pressure is 101.325 kPa unless otherwise noted.

For purposes herein a “polymer” refers to a compound having two or more “mer” units (see below for polyester mer units), that is, a degree of polymerization of two or more, where the mer units can be of the same or different species. A “homopolymer” is a polymer having mer units that are the same species. A “copolymer” is a polymer having two or more different species of mer units. A “terpolymer” is a polymer having three different species of mer units. “Different” in reference to mer units indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “residue” or “unit”, as used herein, means the organic structure of the monomer in its as-polymerized form as incorporated into a polymer, e.g., through polymerization of the corresponding monomer. Throughout the specification and claims, reference to the monomer(s) in the polymer is understood to mean the corresponding as-polymerized form or residue of the respective monomer.

For purposes herein, the glass transition temperature is determined by DSC analysis from the second heating ramp by heating of the sample at 10° C./min from 0° C. to 300° C. The glass transition temperatures are measured as the midpoint of the respective endotherm or exotherm in the second heating ramp.

For purpose herein, proton NMR spectra are collected using a suitable instrument, e.g., a 500 MHz Varian pulsed Fourier transform NMR spectrometer equipped with a variable temperature proton detection probe operating at 120° C. Typical measurement of the NMR spectrum include dissolving of the polymer sample in 1,1,2,2-tetrachloroethane-d2 (“TCE-d2”) and transferring into a 5 mm glass NMR tube. Typical acquisition parameters are sweep width of 10 KHz, pulse width of 30 degrees, acquisition time of 2 seconds, acquisition delay of 5 seconds and number of scans was 120. Chemical shifts are determined relative to the TCE-d2 signal which are set to 5.98 ppm.

Dynamic mechanical thermal analysis (“DMTA”) as used herein refers to analysis conducted according to procedures known in the art. Suitable instruments include those provided by Rheometrics, Inc (TA Instruments, USA) unless stated otherwise. For purposes herein, samples are prepared as small rectangular samples, the whole sample approximately 19.0 mm long by 5 mm wide by 0.5 mm thick polymer samples are molded at approximately 190° C. on either a Carver Lab Press or Wabash Press. The polymer samples are then loaded into the open oven of the instrument between tool clamps on both ends. The dimensions of sample is recorded once sample was stabilized at the initial testing temperature. After the oven and sample has reached the initial testing temperature of −80° C., the test initiated.

For the purposes of the present disclosure, the numbering scheme for the Periodic Table Groups is used as described in Chemical and Engineering News, v.63(5), pg. 27 (1985), e.g., a “Group 4 metal” is an element from Group 4 of the Periodic Table, e.g., Hf, Ti, or Zr.

An “olefin,” alternatively referred to as “alkene,” is a linear, branched, or cyclic compound of carbon and hydrogen having at least one carbon-carbon double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

For purposes of the present disclosure, ethylene shall be considered an α-olefin.

The terms “hydrocarbyl radical,” “hydrocarbyl” and “hydrocarbyl group” are used interchangeably throughout this document. Likewise, the terms “group,” “radical,” and “substituent” are also used interchangeably in this document. For purposes of this disclosure, “hydrocarbyl radical” is defined to be a radical, which contains hydrogen atoms and up to 50 carbon atoms and which may be linear, branched, or cyclic, and when cyclic, aromatic or non-aromatic.

Substituted hydrocarbyl radicals are radicals in which at least one hydrogen atom has been substituted with at least one functional group such as NR^{x}₂, OR^{x}, SeR^{x}, TeR^{x}, PR^{x}₂, AsR^{x}₂, SbR^{x}₂, SR^{x}, BR^{x} and the like or where at least one non-hydrocarbon atom or group has been inserted within the hydrocarbyl radical, such as —O—, —S—, —Se—, —Te—, —N(R^{x})—, ═N—, —P(R^{x})—, ═P—, —As(R^{x})—, ═As—, —Sb(R^{x})—, ═Sb—, —B(R^{x})—, ═B— and the like, where R^{x} is independently a hydrocarbyl or halocarbyl radical, and two or more R^{x} may join together to form a substituted or unsubstituted saturated, partially unsaturated or aromatic cyclic or polycyclic ring structure. Examples of a substituted hydrocarbyls would include —CH₂CH₂—O—CH₃ and —CH₂—NMe₂ where the radical is bonded via the carbon atom, but would not include groups where the radical is bonded through the heteroatom such as —OCH₂CH₃ or —NMe₂.

Silylcarbyl radicals are radicals in which one or more hydrocarbyl hydrogen atoms have been substituted with at least one SiR*₃ containing group or where at least one —Si(R*)₂— has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure.

Substituted silylcarbyl radicals are radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR*₃ and the like or where at least one non-hydrocarbon atom or group has been inserted within the silylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Ge(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure. Substituted silylcarbyl radicals are only bonded via a carbon or silicon atom.

Germylcarbyl radicals are radicals in which one or more hydrocarbyl hydrogen atoms have been substituted with at least one GeR*₃ containing group or where at least one —Ge(R*)₂— has been inserted within the hydrocarbyl radical where R* independently a hydrocarbyl or halocarbyl radical, and two or more R* may join together to form a substituted or unsubstituted saturated, partially unsaturated or aromatic cyclic or polycyclic ring structure. Substituted germylcarbyl radicals are only bonded via a carbon or germanium atom.

Substituted germylcarbyl radicals are radicals in which at least one hydrogen atom has been substituted with at least one functional group such as NR*₂, OR*, SeR*, TeR*, PR*₂, AsR*₂, SbR*₂, SR*, BR*₂, SiR*₃, SnR*₃, PbR*₃ and the like or where at least one non-hydrocarbon atom or group has been inserted within the germylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

Halocarbyl radicals are radicals in which one or more hydrocarbyl hydrogen atoms have been substituted with at least one halogen (e.g., F, Cl, Br, I) or halogen-containing group (e.g., CF₃).

Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂ and the like or where at least one non-carbon atom or group has been inserted within the halocarbyl radical such as —O—, —S—, —Se—, —Te—, —N(R*)—, ═N—, —P(R*)—, ═P—, —As(R*)—, ═As—, —Sb(R*)—, ═Sb—, —B(R*)—, ═B— and the like, where R* is independently a hydrocarbyl or halocarbyl radical provided that at least one halogen atom remains on the original halocarbyl radical. Additionally, two or more R* may join together to form a substituted or unsubstituted saturated, partially unsaturated or aromatic cyclic or polycyclic ring structure. Substituted halocarbyl radicals are only bonded via a carbon atom.

The term “aryl” or “aryl group” means a monocyclic or polycyclic aromatic ring and the substituted variants thereof, including but not limited to, phenyl, naphthyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. The term “substituted aryl” means: 1) an aryl group where a hydrogen has been replaced by a substituted or unsubstituted hydrocarbyl group, a substituted or unsubstituted halocarbyl group, a substituted or unsubstituted silylcarbyl group, or a substituted or unsubstituted germylcarbyl group. The term “substituted heteroaryl” means: 1) a heteroaryl group where a hydrogen has been replaced by a substituted or unsubstituted hydrocarbyl group, a substituted or unsubstituted halocarbyl group, a substituted or unsubstituted silylcarbyl group, or a substituted or unsubstituted germylcarbyl group.

For nomenclature purposes, the following numbering schemes are used for indenyl, trihydro-s-indacenyl, trihydro-as-indacenyl, tetrahydro-s-indacenyl and tetrahydro-as-indacenyl ligands.

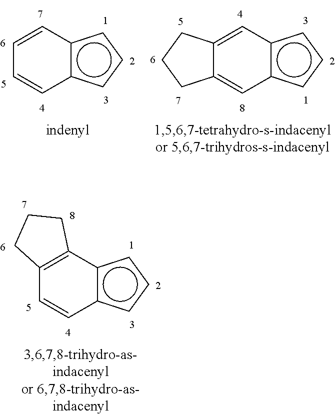

As used herein, Mn is number average molecular weight, Mw is weight average molecular weight, and Mz is z average molecular weight, wt % is weight percent, and mol % is mole percent. Molecular weight distribution (MWD), also referred to as polydispersity, is defined to be Mw divided by Mn. Unless otherwise noted, all molecular weight units (e.g., Mw, Mn, Mz) are g/mol. The following abbreviations may be used herein: ENB is 5-ethylidene-2-norbornene, Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, Bn is benzyl, Cp is cyclopentadienyl, Ind is indenyl, and MAO is methylalumoxane.

For purposes herein, a “catalyst system” is the combination of at least one catalyst compound, at least one activator, an optional co-activator, and an optional support material. The catalyst system described herein may or may not be supported (i.e., “unsupported”). For purposes of the present disclosure and the claims thereto, when catalyst systems are described as comprising neutral stable forms of the components, it is well understood by one of ordinary skill in the art, that the ionic form of the component is the form that reacts with the monomers to produce polymers.

In the description herein, the metallocene catalyst may be described as a catalyst precursor, a pre-catalyst compound, metallocene catalyst compound or a transition metal compound, and these terms are used interchangeably.

A metallocene catalyst is defined as an organometallic transition metal compound with at least one π-bound cyclopentadienyl moiety (or substituted cyclopentadienyl moiety) bound to a transition metal.

For purposes of the present disclosure in relation to metallocene catalyst compounds, the term “substituted” means that one or more hydrogen atoms have been replaced with a hydrocarbyl, heteroatom (such as a halide), or a heteroatom containing group, (such as silylcarbyl, germylcarbyl, halocarbyl, etc.). For example, methyl cyclopentadiene (Cp) is a Cp group substituted with a methyl group.

For purposes of the present disclosure, “alkoxides” include those where the alkyl group is a C₁ to C₁₀ hydrocarbyl. The alkyl group may be straight chain, branched, or cyclic. The alkyl group may be saturated or unsaturated. In some embodiments, the alkyl group may comprise at least one aromatic group.

### Copolymers

Copolymers of the present disclosure can have an α-olefin monomer, an optional comonomer, an optional diene, and a metal alkenyl, such as an aluminum vinyl. For example, a copolymer can have greater than or equal to about 50 wt % and less than or equal to about 99.9 wt % of at least one C₂-C₆₀ α-olefin, based on the total weight of the copolymer. In some embodiments, a copolymer can have greater than or equal to about 0.1 wt % and less than or equal to about 20 wt % diene units, based on the total weight of the copolymer. A copolymer can have greater than or equal to about 0.1 wt % and less than or equal to about 10 wt % aluminum vinyl units, based on the total weight of the copolymer.

In at least one embodiment, the copolymer can have an α-olefin monomer content of about 50 wt % to about 99.9 wt %, such as about 60 wt % to about 99.9 wt %, such as from about 70 wt % to about 99.9 wt %, such as from about 80 wt % to about 99.5 wt %, such as from about 85 wt % to about 99 wt %, such as from about 90 wt % to about 99 wt %, such as from about 93 wt % to about 99 wt %, such as from about 95 wt % to about 99 wt %, based on the weight of the copolymer.

In at least one embodiment, the copolymer can have an optional comonomer content of about 0.1 wt % to about 49 wt %, such as about 0.5 wt % to about 45 wt %, such as from about 1 wt % to about 40 wt %, such as from about 5 wt % to about 40 wt %, such as from about 10 wt % to about 35 wt %, such as from about 15 wt % to about 30 wt %, such as from about 20 wt % to about 30 wt %, such as from about 25 wt % to about 30 wt %, based on the weight of the copolymer.

The copolymer can further include an optional diene content of 0.01 wt % to about about 20 wt % (such as from about 0.1 wt % to about 10 wt %, such as from about 0.5 wt % to about 5 wt %, such as from about 1 wt % to about 3 wt %, such as from about 1.5 wt % to about 3 wt %, based on the weight of the copolymer).

The copolymer can further include a metal alkenyl content of about 0.01 wt % to about 20 wt % (such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer). The copolymer can also have a glass transition temperature of −100° C. to 5° C., and Mw of 50 kg/mol to 5,000 kg/mol.

In at least one embodiment, copolymer can include:
1) propylene present at 50 wt % to about 99.89 wt % (such as from about 70 wt % to about 99.5 wt %, such as from about 80 wt % to about 99 wt %, such as from about 90 wt % to about 99 wt %, based on the weight of the copolymer) of ethylene;
2) ethylene present at 0.1 wt % to about 50 wt % (such as from about 1 wt % to about 30 wt %, such as from about 3 wt % to about 20 wt %, based on the weight of the copolymer);
3) optional diene present at 0.01 wt % to about about 20 wt % (such as from about 0.1 wt % to about 10 wt %, such as from about 0.5 wt % to about 5 wt %, such as from about 1 wt % to about 3 wt %, such as from about 1.5 wt % to about 3 wt %, based on the weight of the copolymer); and
4) metal alkenyl present at about 0.01 wt % to about 20 wt % (such as from about 0.1 wt % to about 10 wt %, such as from about 0.1 wt % to about 5 wt %, such as from about 0.3 wt % to about 3 wt %, such as from about 0.5 wt % to about 2.0, such as from about 0.5 wt % to about 1.5 wt %, based on the weight of the copolymer); and
5) a glass transition temperature of −60 to 5° C., and Mw of 50 to 5,000 kg/mol.

Monomers and optional comonomers independently include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer comprising one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups. In another embodiment, the monomer includes propylene and an optional comonomer comprising one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers may include ethylene, propylene, butene, pentene, hexene, heptene, octene, nonene, decene, undecene, dodecene, norbomene, dicyclopentadiene, cyclopentene, cycloheptene, cyclooctene, cyclododecene, 7-oxanorbornene, substituted derivatives thereof, and isomers thereof, such as hexene, heptene, octene, nonene, decene, dodecene, cyclooctene, 1-hydroxy-4-cyclooctene, 1-acetoxy-4-cyclooctene, 5-methylcyclopentene, cyclopentene, norbornene, and their respective homologs and derivatives, such as norbornene.

In at least one embodiment, an α-olefin monomer or comonomer can be a linear α-olefin. Linear α-olefins (LAOs) can be substituted or unsubstituted C₆-C₆₀ LAOs, such as C₆-C₅₀ LAOs, such as C₈-C₄₀ LAOs, such as C₁₀-C₃₀ LAOs, such as C₁₀-C₂₀ LAOs, such as C₁₅-C₂₀ LAOs, alternatively C₈-C₁₆ LAOs, such as C₈-C₁₂ LAOs. LAOs can have some branching. For example, an LAO may have one or more pendant methyl or ethyl substitutions along the LAO backbone. In some embodiments, an LAO is free of branching, e.g., is entirely linear. In at least one embodiment, a copolymer has linear α-olefin units selected from 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-icosene, 1-henicosene, 1-docosene, 1-tricosene, 1-tetracosene, 1-pentacosene, and combination(s) thereof.

In at least one embodiment, the copolymers can have an α-olefin content comprising ethylene and a comonomer content comprising propylene. An ethylene content can be about 50 wt % to about 99.9 wt %, such as from about 50 wt % to about 99 wt %, such as from about 50 wt % to about 90 wt %, such as from about 50 wt % to about 80 wt %, such as from about 50 wt % to about 70 wt %, such as from about 50 wt % to about 60 wt %, such as from about 50 wt % to about 55 wt %, based on the weight of the copolymer. A propylene content can be about 0.1 wt % to about 50 wt %, such as from about 1 wt % to about 50 wt %, such as from about 10 wt % to about 50 wt %, such as from about 20 wt % to about 50 wt %, such as from about 30 wt % to about 50 wt %, such as from about 40 wt % to about 50 wt %, such as from about 45 wt % to about 50 wt %, based on the weight of the copolymer.

In at least one embodiment, copolymers can have an α-olefin content comprising propylene and a comonomer content comprising ethylene. A propylene content can be about 50 wt % to about 99.9 wt %, such as from about 50 wt % to about 99 wt %, such as from about 50 wt % to about 90 wt %, such as from about 50 wt % to about 80 wt %, such as from about 50 wt % to about 70 wt %, such as from about 50 wt % to about 60 wt %, such as from about 50 wt % to about 55 wt %, based on the weight of the copolymer. An ethylene content can be about 0.1 wt % to about 50 wt %, such as from about 1 wt % to about 50 wt %, such as from about 10 wt % to about 50 wt %, such as from about 20 wt % to about 50 wt %, such as from about 30 wt % to about 50 wt %, such as from about 40 wt % to about 50 wt %, such as from about 45 wt % to about 50 wt %, based on the weight of the copolymer.

In at least one embodiment, copolymers can have a diene content of about 0.1 wt % to about 40 wt %, such as from about 0.1 wt % to about 30 wt %, such as from about 0.1 wt % to about 20 wt %, such as from about 0.1 wt % to about 10 wt %, such as from about 0.5 wt % to about 10 wt %, such as from about 1 wt % to about 10 wt %, such as from about 1.5 wt % to about 8 wt %, such as from about 2 wt % to about 6 wt %, such as from about 2 wt % to about 5 wt %, alternatively from about 8 wt % to about 12 wt %, based on the weight of the copolymer.

In at least one embodiment, dienes can be substituted or unsubstituted dienes selected from C₄-C₆₀ dienes, such as C₅-050 dienes, such as C₅-C₄₀ dienes, such as C₅-C₃₀ dienes, such as C₅-C₂₀ dienes, such as C₆-C₁₅ dienes, such as C₆-C₁₀ dienes, such as C₇-C₉ dienes, such as a substituted or unsubstituted C₇ diene, C₈ diene, or C₉ diene. In at least one embodiment, a copolymer has diene units of a C₇ diene. In at least one embodiment, a diene is a substituted or unsubstituted α,Ω-diene (e.g., the diene units of the copolymer are formed from di-vinyl monomers). The dienes can be linear di-vinyl monomers. In at least one embodiment, a diene is selected from butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and combination(s) thereof. In some embodiments, a diene is selected from 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and combination(s) thereof. In at least one embodiment, a diene is selected from cyclopentadiene, vinylnorbornene, norbornadiene, 5-ethylidene-2-norbornene, 5-vinyl-2-norbornene, divinylbenzene, dicyclopentadiene, and combination(s) thereof. In at least one embodiment, a copolymer has diene units of 5-ethylidene-2-norbornene.

In at least one embodiment, copolymers can have a metal alkenyl content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

The metal alkenyl is typically represented by the formula:

Q(R′)_{z-v}(R)ᵥ

wherein Q is a group 1, 2, 12 or 13 metal, such as Al, B Ga, Mg, Li, or Zn; R is a hydrocarbenyl group containing 4 to 20 carbon atoms having an allyl chain end, R′ is a hydrocarbyl group containing 1 to 30 carbon atoms, z is 1, 2, or 3, and v is 1, 2 or 3, where z−v is 0, 1 or 2.

Suitable metal alkenyls can be aluminum vinyl (alkenylaluminum). In at least one embodiment, metal alkenyls can include a metal having a carbon chain with a vinyl end group and two additional bulky groups, such as isobutyl groups. The bulky groups can sterically hinder their respective Al—C bonds making CO₂ insertion difficult at those locations, thereby promoting selective insertion of CO₂ on the alkenyl side having the vinyl chain end. In at least one embodiment, aluminum vinyl units can be aluminum vinyl transfer agents (AVTAs), which can be any aluminum agent that contains at least one transferrable group that has an end-vinyl group also referred to as an allyl chain end. An allyl chain end is represented by the formula H₂C═CH—CH₂—. “Allylic vinyl group,” “allyl chain end,” “vinyl chain end,” “vinyl termination,” “allylic vinyl group,” “terminal vinyl group,” and “vinyl terminated” are used interchangeably herein and refer to an allyl chain end. An allyl chain end is not a vinylidene chain end or a vinylene chain end.

Useful groups that can be bound to a metal (such as aluminum) and containing an allyl chain end, are represented by the formula CH₂═CH—CH₂—R—, where R represents a hydrocarbeneyl group or a substituted hydrocarbeneyl group, such as a C₁ to C₂₀ alkylene, preferably methylene (CH₂), ethylene [(CH₂)₂], propandiyl [(CH₂)₃], butandiyl [(CH₂)₄], pentandiyl [(CH₂)₅], hexandiyl [(CH₂)₆], heptandiyl [(CH₂)₇], octandiyl [(CH₂)₈], nonandiyl [(CH₂)₉], decandiyl [(CH₂)₁₀], undecandiyl [(CH₂)₁₁], dodecandiyl [(CH₂)₁₂], or an isomer thereof. Useful transferable groups are preferably non-substituted linear hydrocarbeneyl groups.

In some embodiments, the aluminum vinyl is represented by the Formula (II):

Al(R′)₃₋ᵥ(R)ᵥ

where R is a hydrocarbenyl group containing 4 to 20 carbon atoms having an allyl chain end, R′ is a hydrocarbyl group containing 1 to 30 carbon atoms, and v is 1 to 3 alternately v is 1.1 to 2.9, alternately 1.5 to 2.9, alternately 1.5 to 2.5, alternately 1.8 to 2.2. The compounds represented by the formula Al(R′)₃₋ᵥ(R)ᵥ are typically a neutral species, but anionic formulations may be envisioned, such as those represented by Formula (III): [Al(R′)_{4-w}(R)_{w}]⁻, where w is 0.1 to 4, alternately 1.1 to 4, R is a hydrocarbenyl group containing 4 to 50 carbon atoms having an allyl chain end, and R′ is a hydrocarbyl group containing 1 to 50 carbon atoms.

In at least one embodiment of a formula for an aluminum vinyl transfer agent described herein, each R′ is independently chosen from C₁ to C₅₀ hydrocarbyl groups (such as a C₁ to C₂₀ alkyl groups, preferably methyl, ethyl, propyl, butyl, pentyl, hexyl, heptyl, octyl, nonyl, decyl, undecyl, dodecyl, or an isomer thereof), and R is represented by the formula:

—(CH₂)ₙCH═CH₂

where n is an integer from 2 to 18, preferably between 5 to 18, preferably 5 to 12, preferably 5 to 6. In at least one embodiment, particularly useful AVs include isobutyl-di(oct-7-en-1-yl)-aluminum, isobutyl-di(dec-9-en-1-yl)-aluminum, isobutyl-di(non-8-en-1-yl)-aluminum, isobutyl-di(hept-6-en-1-yl)-aluminum, dimethyl(oct-7-en-1-yl)aluminum, diethyl(oct-7-en-1-yl)aluminum, dibutyl(oct-7-en-1-yl)aluminum, diisobutyl(oct-7-en-1-yl)aluminum, diisobutyl(non-8-en-1-yl) aluminum, diisobutyl(dec-9-en-1-yl)aluminum, diisobutyl(dodec-10-en-1-yl)aluminum, diisobutyl(hept-6-en-1-yl)aluminum, diethyl(hept-6-en-1-yl)aluminum, dimethyl(hept-6-en-1-yl)aluminum and the like. Mixtures of one or more AVs may also be used. In some embodiments, isobutyl-di(oct-7-en-1-yl)-aluminum, isobutyl-di(dec-9-en-1-yl)-aluminum, and/or isobutyl-di(non-8-en-1-yl)-aluminum, isobutyl-di(hept-6-en-1-yl)-aluminum are used.

Useful aluminum vinyl include organoaluminum compound reaction products between an aluminum reagent (AlR^{a}₃) and an alkyl diene. Suitable alkyl dienes include those that have two “α-olefins” at two termini of the carbon chain. The alkyl diene can be a straight chain or branched alkyl chain and substituted or unsubstituted. Exemplary alkyl dienes include but are not limited to, for example, 1,3-butadiene, 1,4-pentadiene, 1,5-hexadiene 1,6-heptadiene, 1,7-octadiene, 1, 8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, 1,16-heptadecadiene, 1,17-octadecadiene, 1,18-nonadecadiene, 1,19-eicosadiene, 1,20-heneicosadiene, etc. Exemplary aluminum reagents include triisobutylaluminum, diisobutylaluminumhydride, isobutylaluminumdihydride and aluminum hydride (AlH₃).

In any embodiment of the invention described herein, R is butenyl, pentenyl, heptenyl, or octenyl. In some embodiments, R is octenyl.

In any embodiment of the invention described herein, R′ is methyl, ethyl, propyl, isobutyl, or butyl. In some embodiments, R′ is isobutyl.

In any embodiment of the invention described herein, Ra is methyl, ethyl, propyl, isobutyl, or butyl. In some embodiments, Ra is isobutyl.

In any embodiment of the invention described herein, v is about 2, or v is 2.

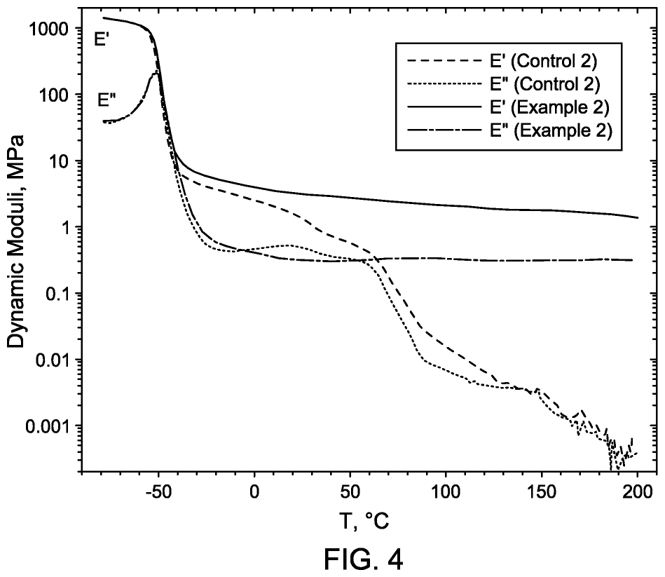

In still another aspect, the aluminum vinyl unit has less than 50 wt % dimer present, based upon the weight of the AV, such as less than 40 wt %, such as less than 30 wt %, such as less than 20 wt %, such as less than 15 wt %, such as less than 10 wt %, such as less than 5 wt %, such as less than 2 wt %, such as less than 1 wt %, such as 0 wt % dimer. Alternately dimer is present at from 0.1 to 50 wt %, alternately 1 to 20 wt %, alternately at from 2 to 10 wt %. Dimer is the dimeric product of the alkyl diene used in the preparation of the AV. The dimer can be formed under certain reaction conditions, and is formed from the insertion of a molecule of diene into the Al—R bond of the AV, followed by beta-hydride elimination (see FIG. 4 of US 2018-0194872). For example, if the alkyl diene used is 1,7-octadiene, the dimer is 7-methylenepentadeca-1,14-diene. Similarly, if the alkyl diene is 1,9-decadiene, the dimer is 9-methylenenonadeca-1,18-diene.

Useful AV compounds can be prepared by combining an alkyl aluminum (aluminum reagent) having at least one secondary alkyl moiety such as triisobutylaluminum and/or at least one hydride, such as a dialkylaluminum hydride, a monoalkylaluminum dihydride or aluminum trihydride (aluminum hydride, AlH₃) with an alkyl diene and heating to a temperature that causes release of an alkylene byproduct. The reaction can take place in the absence of solvent (neat) or in the presence of a non-polar non-coordinating solvent such as a C₅-C₁₀ alkane, or an aromatic solvent such as hexane, pentane, toluene, benzene, xylenes, and the like, or combinations thereof. The reaction preferably is heated from 60° C. to 110° C. Lower reaction temperatures from 60° C. to 80° C. are preferred if longer reaction times are used such as stirring with heat for 6-24 hours. Higher reaction temperatures from 90° C. to 110° C. are preferred if shorter reaction times are used such as stirring with heat for 1 to 2 hours. At a reaction temperature from 65° C. to 75° C., the reaction is preferably heated and stirred for 6-18 hours, preferably 8-12 hours. At a reaction temperature form 100° C. to 110° C., the reaction is preferably heated and stirred for 1 to 2 hours. Combinations of higher reaction temperature and lower reaction temperatures can be used, for example heating and stirring the reaction for 1 hour at 110° C. followed by heating and stirring at 65° C. to 75° C. for 8-12 hours. Lower reaction temperatures for longer times or higher reaction temperatures for shorter times favor formation of the AV with v=2, and disfavors formation of dimer. The AV with v=3 typically occurs at higher reaction temperatures and longer times, and is accompanied with dimer formation.

After the reaction is complete, solvent, if present, can be removed and the product can be used directly without further purification.

In at least one embodiment, copolymers can have an aluminum vinyl content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

In at least one embodiment, metal alkenyls can be alkenylborane units. In at least one embodiment, alkenylborane units can be any aluminum vinyl unit listed herein having borane substituted in place of aluminum.

In at least one embodiment, copolymers can have an alkenylborane content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

In at least one embodiment, metal alkenyls can be alkenyl magnesium units. In at least one embodiment, alkenyl magnesium units can be any magnesium vinyl unit listed herein having magnesium substituted in place of aluminum.

In at least one embodiment, copolymers can have an alkenylmagnesium content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

In at least one embodiment, metal alkenyls can include any suitable compound having a metal and a vinyl end group. In at least one embodiment, metal alkenyls can include any group 13 metal, such as B, Al, Ga, In. In at least one embodiment, a metal alkenyl can include any aluminum vinyl unit listed herein having another group 13 metal substituted in place of aluminum.

In at least one embodiment, metal alkenyls can include any group 1, 2 or 12 metal, such as Li, Mg or Zn. In at least one embodiment, a metal alkenyl can include any aluminum vinyl unit listed herein having another group 1, 2 or 12 metal substituted in place of aluminum.

Once polymerization has been performed, copolymers can have pendant metal groups, such as pendant aluminum groups. In other embodiments, copolymers can have pendant groups of B, Ga, In, Li, Mg or Zn.

As described in more detail below, the copolymers can be treated with a suitable reagent such that pendant aluminum groups (or other pendant groups having Group 1, 2, 12 or 13 atoms) are modified to form copolymers having carboxylate or sulfonate pendant groups. See US 2018/0194872 for synthesis methods for aluminum vinyl compounds.

### Copolymer Properties

In at least one embodiment, copolymers can have an Mw value of about 5,000 g/mol or greater, such as from about 5,000 g/mol to about 2,000,000 g/mol, such as from about 10,000 g/mol to about 1,000,000 g/mol, such as from about 10,000 g/mol to about 500,000 g/mol, such as from about 10,000 g/mol to about 300,000 g/mol, such as from about 20,000 g/mol to about 200,000 g/mol, such as from about 20,000 g/mol to about 100,000 g/mol, such as from about 30,000 g/mol to about 90,000 g/mol, such as from about 40,000 g/mol to about 80,000 g/mol, such as from about 50,000 g/mol to about 70,000 g/mol, such as from about 55,000 g/mol to about 65,000 g/mol, such as from about 60,000 g/mol to about 65,000 g/mol.

In at least one embodiment, copolymers can have an Mn value of 1,000 g/mol or greater, such as from about 1,000 g/mol to about 400,000 g/mol, such as from about 1,000 g/mol to about 200,000 g/mol, such as from about 1,000 g/mol to about 100,000 g/mol, such as from about 1,000 g/mol to about 50,000 g/mol, such as from about 5,000 g/mol to about 40,000 g/mol, such as from about 10,000 g/mol to about 30,000 g/mol, such as from about 15,000 g/mol to about 25,000 g/mol, such as from about 18,000 g/mol to about 20,000 g/mol.

In at least one embodiment, copolymers having relatively low values of Mw may be effective in coating applications. In at least one embodiment, copolymers having relatively high values of Mw may be effective for materials that experience many loading/unloading cycles, such as tires. In at least one embodiment, copolymers having values of Mw of about 400,000 g/mol or greater may make effective use in certain rubbers.

In at least one embodiment, copolymers can have an Mw/Mn (polydispersity index) value of about 1 to about 10, such as from about 2 to about 5, such as from about 3 to about 4.

Due to strong ion cluster formation, the ionomers are typically not soluble in any solvent. The moments of molecular weight of the metal alkenyl containing copolymer are determined by acidification of the ionomers to make them soluble in trichlorobenzene TCB. Thereafter, Gel Permeation Chromatography (GPC), see experimental section below) is performed on the acidified copolymers to measure the moments of molecular weight. For purposes of this invention and the claims thereto, the moments of molecular weight of the acidified polymers shall be considered the moments of molecular weight of the polymer prior to be acidified.

In at least one embodiment, the copolymers can have a glass transition temperature (T_{g}) as determined by differential scanning calorimetry (DSC) as described below of −30° C. or less, such as from about −30° C. to about −100° C., such as from about −40° C. to about −60° C., such as from about −45° C. to about −55° C., such as from about −48° C. to about −52° C., such as from about −49° C. to about −50° C., alternatively from about −51° C. to about −52° C.

The comonomer composition can be determined by NMR the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH₃end/1000TC) is obtained by weight-averaging the chain-end correction over the molecular-weight range. Then

w2b=f*bulk CH3/1000TC

bulk SCB/1000TC =bulk CH_{3/1000}TC−bulk CH₃end/1000TC

and bulk SCB/1000TC is converted to bulk w2 in the same manner as described above.

### Ionomers

lonomers of the present disclosure can have a copolymer and a metal cation content. After oxidation of a copolymer by introducing an oxidizing agent to the reactor, an ionomer can be formed having an α-olefin content and an anion alkenyl content. In other words, metal alkenyl moieties of a copolymer are transformed into anion alkenyl moieties to form an ionomer, where the copolymer can have any comonomer composition described herein.

In at least one embodiment, an ionomer can have from about 50 wt % to about 99.9 wt % C₂-C₆₀ α-olefin units, based on the weight of the copolymer; and from about 0.1 wt % to about 10 wt % anion alkenyl units, based on the weight of the ionomer. In at least one embodiment, the anion alkenyl units have the formula —R(A⁻)—, where R is an alkyl group containing 2 to 10 carbon atoms, and where A⁻ is an anionic group. The above formula shows that the alkyl group, which is represented by R, is divalent with the rest of the polymer backbone. In at least one embodiment, the anionic group is a carboxylate, and the anion alkenyl units have the formula —R(—R^{A}_{X}COOAl(OR^{B})₂)—, where R is preferably a linear, branched or cyclic alkyl group containing 2 to 40 carbon atoms, R^{A} is a hydrocarbyl group (typically an alkyl having 2 to 18 carbon atoms), R^{B} is a hydrocarbyl group (typically an alkyl having 2 to 18 carbon atoms), and X is 0 or 1, indicating the presence or absence of the hydrocarbyl group.

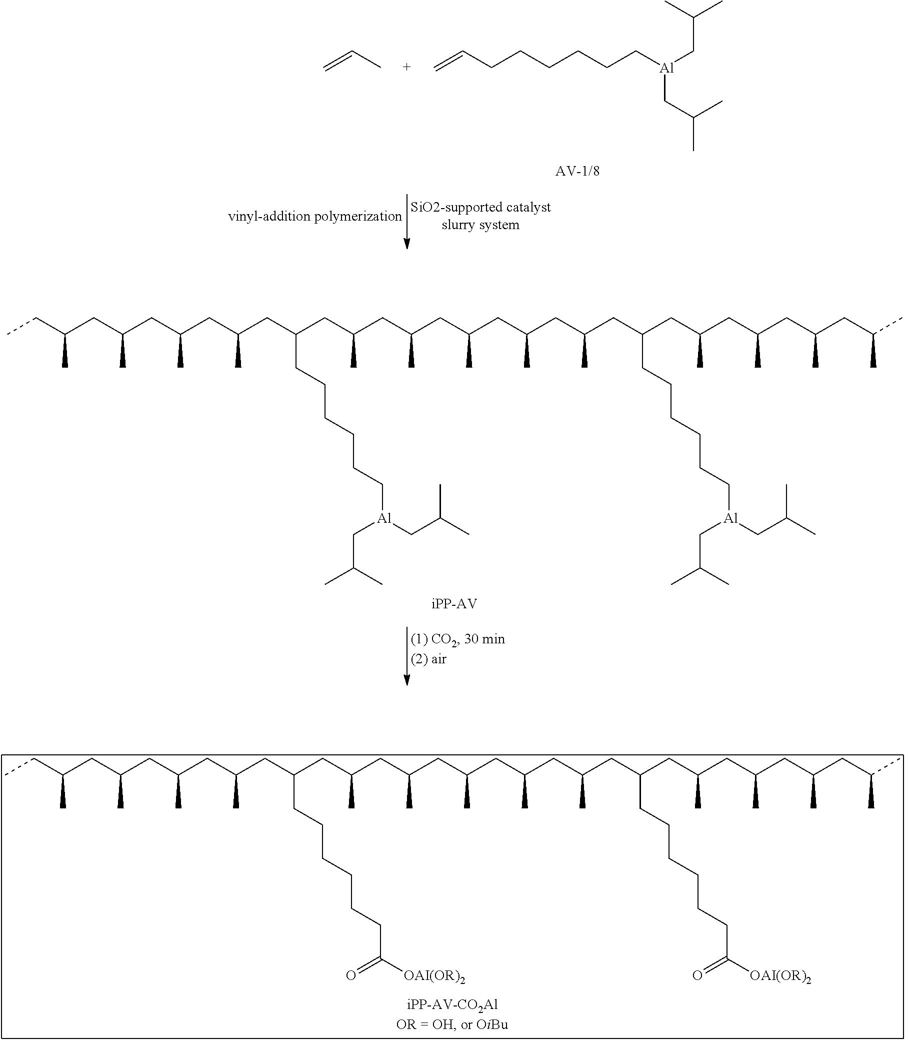

In at least one embodiment, copolymers can have pendant carboxylate anion groups. In at least one embodiment, copolymers can have pendant carboxylic acid groups. In at least one embodiment, copolymers can have pendant sulfonate anion groups. In at least one embodiment, copolymers can have pendant sulfonic acid groups. In at least one embodiment, copolymers can have pendant phosphonate anion groups. In at least one embodiment, copolymers can have pendant phosphonic acid groups. In at least one embodiment, copolymers can include each acid group and its corresponding anion, depending on a dissociation constant of each pendant acid group in solution.

In at least one embodiment, anion alkenyl units can include carboxylate anions. In at least one embodiment, copolymers can have a carboxylate anion alkenyl unit content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

In at least one embodiment, anion alkenyl units can include sulfonate anions. In at least one embodiment, ionomers can have a sulfonate anion alkenyl unit content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the ionomer.

In at least one embodiment, anion alkenyl units can include phosphonate anions. In at least one embodiment, ionomers can have a phosphonate anion alkenyl unit content of about 0.01 wt % to about 20 wt %, such as from about 0.1 wt % to about 10 wt %, such as from about 0.1 wt % to about 5 wt %, such as from about 0.3 wt % to about 3 wt %, such as from about 0.5 wt % to about 1.5 wt %, based on the weight of the copolymer.

In at least one embodiment, ionomers have metal cations. Metal cations can include any suitable metal. In at least one embodiment, metal cations can be selected from an alkali metal, an alkaline earth metal, a group 3-12 metal, a group 13-16 metal, and combination(s) thereof. In at least one embodiment, alkali metals can include Li, Na, K, Rb, Cs, Fr, or combination(s) thereof, such as Li, Na, and K; alkaline earth metals can include Be, Mg, Ca, Sr, Ba, Ra, or combination(s) thereof, such as Mg and Ca; and group 12 metals can include Zn, Cd, Hg, Cn, or combination(s) thereof, such as Zn. In at least one embodiment, metal cations can include Sc, Y, Ti, Zr, Hf, Rf, V, Nb, Ta, Db, Cr, Mo, W, Sg, Mn, Tc, Re, Bh, Fe, Ru, Os, Hs, Co, Rh, Ir, Mt, Ni, Pd, Pt, Ds, Cu, Ag, Au, Rg, Al, Ga, In, Tl, Nh, Sn, Pb, Fl, Bi, Mc, Po, Lv, or combination(s) thereof.

### Processes to Produce Ionomers

In at least one embodiment, a process to produce an ionomer can include introducing a metal cation to the copolymer having a pendant anion or acid group.

In at least one embodiment, the metal cation can be introduced to the copolymer by adding a solution containing the metal cation. In at least one embodiment, the metal cation is bound to a basic compound (e.g., an anion). In at least one embodiment, the base can include a tert-butoxide, a hydroxide, or any other suitable anions including halides, sulfate, nitrate, nitrite, sulfide, phosphates, borates, and aluminates. For example, an anion can be selected from sodium tert-butoxide, potassium tert-butoxide, sodium hydroxide, potassium hydroxide, or combination(s) thereof. In at least one embodiment, a suitable anion can be a bulky anion, such as a tert-butoxide or a borate.

In at least one embodiment, the base can be dissolved in alcohol, such as methanol, (e.g., in a mixed solvent such as 90:10 toluene/alcohol), or in any other suitable solvent.

In at least one embodiment, an ion exchange occurs between the metal cation and the pendant anion group to form an ionomer having a metal cation content.

In at least one embodiment, a concentration of the metal cation may be from about 0.05 wt % to about 30 wt %, based on the total weight of the ionomer, such as about 1 wt % to about 25 wt % or about 5 wt % to about 20 wt %. The concentration of the metal cation also range from a low of about 1, 5, or 10 wt % to a high of about 15, 25, or 30 wt %, based on the total weight of the ionomer.

In at least one embodiment, ion exchange proceeds at a reactor temperature of about 23° C. or greater, such as 23° C. to about 150° C., such as from about 40° C. to about 100° C., such as from about 50° C. to about 90° C., such as from about 60° C. to about 80° C., such as from about 65° C. to about 75° C., such as about 70° C.

### Ionomer Properties

In at least one embodiment, ionomers produced herein can have a weight average molecular weight (Mw) of at least 50,000 g/mol, such as from 50,000 to 1,000,000 g/mol, such as from 75,000 to 600,000 g/mol.

In at least one embodiment, ionomers produced herein can have a number average molecular weight (Mn) of at least 21,000 g/mol, such as from 50,000 to 2,500,000 g/mol, such as from 75,000 to 2,000,000 g/mol, such as from 250,000 to 1,500,000 g/mol.

In at least one embodiment, ionomers produced herein can have a molecular weight distribution (Mw/Mn) of from about 1.01 to 10, such as from 1.5 to 6 such as 2 to 4.

In at least one embodiment, ionomers produced herein have an Mw/Mn of from about 2 to about 4, and Mw of about 50,000 g/mol or more, and an Mn of about 21,000 g/mol or more.

In at least one embodiment, ionomers can have a maximum elastic range (% strain at yield) of about 100% strain or greater, such as from about 300% or greater, such as from about 400% or greater, alternatively from about 100% strain to about 1,000% strain, such as from about 200% strain to about 800% strain, such as from about 300% strain to about 600% strain, such as from about 400% strain to about 500% strain, such as about 460% strain, when determined according to ASTM D638.

In at least one embodiment, ionomers can have a strain to breakage of about 100% or greater, such as about 300% or greater, such as about 500% or greater, alternatively from about 100% to about 1,000%, such as about 200% to about 800%, such as from about 400% to about 700%, such as from about 500% to about 600%, such as about 570%, when determined according to ASTM D638.

In at least one embodiment, ionomers can have a tensile set, at 200% strain, of about 100% or less, such as from about 0% to about 80%, such as from about 20% to about 60%, such as from about 40% to about 50%, such as about 45%.

In at least one embodiment, ionomers can have a modulus of elasticity (Young's Modulus, E), at 40° C., of less than or equal to about 5 MPa, less than or equal to about 4 MPa, less than or equal to about 3 MPa, less than or equal to about 2 MPa, or less than or equal to about 1 MPa.

In at least one embodiment, the ionomers can have a glass transition temperature (T_{g}), as determined by differential scanning calorimetry (DSC) as described below, of −30° C. or less, such as from about −30° C. to about −100° C., such as from about −40° C. to about −60° C., such as from about −45° C. to about −55° C., such as from about −48° C. to about −52° C., such as from about −49° C. to about −50° C., alternatively from about −51° C. to about −52° C.

In at least one embodiment, the ionomers can have a crystallization temperature (T_{c}), as determined by differential scanning calorimetry (DSC) as described below, of about −50° C. to about 100° C., such as from about −30° C. to about 80° C., such as from about −10° C. to about 60° C., such as from about 10° C. to about 40° C.

In at least one embodiment, the ionomers can have a melting temperature (Tₘ), as determined by differential scanning calorimetry (DSC) as described below, of about −45° C. to about 105° C., such as from about −25° C. to about 85° C., such as from about −5° C. to about 65° C., such as from about 15° C. to about 45° C.

In at least one embodiment, the ionomers can have a heat of fusion (H_{f}), as determined by differential scanning calorimetry (DSC) as described below, of about 5 J/g to about 100 J/g, such as from about 15 J/g to about 80 J/g, such as from about 25 J/g to about 60 J/g, such as from about 35 J/g to about 40 J/g.

In at least one embodiment, the ionomers can have a crystallinity (X_{c}), of about 0% to about 65%, such as from about 10% to about 55%, such as from about 20% to about 45%, such as from about 30% to about 35%.

In at least one embodiment, the ionomers can have a Youngs modulus (E, of about 0.1 MPa to about 50 MPa, such as from about 0.2 MPa to about 20 MPa, such as from about 0.5 MPa to about 10 MPa, such as from about 1 MPa to about 5 MPa.

In at least one embodiment, the ionomers can have an ultimate tensile strength of about 1 MPa to about 25 MPa, such as from about 2 MPa to about 20 MPa, such as from about 5 MPa to about 15 MPa, such as from about 10 MPa to about 12.5 MPa.

In at least one embodiment, the ionomers can have an elongation at break of about 20% to about 800%, such as from about 50% to about 600%, such as from about 100% to about 400%, such as from about 150% to about 200%.

Properties of the ionomers may be influenced by ion content. In that regard, ion content can be increased by at least one of: increasing an aluminum vinyl unit content in copolymer precursors, increasing an extent of an oxidizing reaction to increase a conversion of aluminum pendant groups to carboxylate anions, increasing an extent of ion exchange to promote ionomer conversion or combination(s) thereof. In any case, an ionic content can be increased, thereby forming a stronger ionic network.

In at least one embodiment, an extent of an oxidizing reaction, normalized to initial moles of metal in the metal alkenyl, can be about 0.5 to 1, such as from about 0.7 to 1, such as from about 0.9 to 1. The extent of the oxidizing reaction can be determined by measuring consumption of distal hydrocarbyls bound to the metal alkenyl via NMR.

In at least one embodiment, an extent of ion exchange, normalized to initial moles of anion, can be about 0.5 to 1, such as from about 0.7 to 1, such as from about 0.9 to 1. The extent of ion exchange can be determined by measuring a concentration of metal cations in the ionomer via FTIR spectroscopy in comparison to a standard solution of the metal cation.

Properties of ionomers may be influenced by temperature. For example, in order to reprocess an ionomeric article, the temperature can be increased to lower an overall ionic strength of the ionomer and increase an ability of the ionomer to flow. This ability to change a shape of the ionomers at elevated temperature can improve molding applications.

In at least one embodiment, ionomers can have local ion clustering. Such ion clustering can provide ionomers exhibiting physical behavior similar to cross-linked rubbers.

### Additives

lonomers of the present disclosure may be mixed with one or more additives to form an ionomer composition. The additives may include reinforcing and non-reinforcing fillers, antioxidants, stabilizers, processing oils (or other solvent(s)), compatibilizing agents, lubricants (e.g., oleamide), antiblocking agents, antistatic agents, waxes, coupling agents for the fillers and/or pigment, pigments, flame retardants, antioxidants, or other processing aids, or combination(s) thereof.

Ionomer compositions of the present disclosure can include additives such that the additives (e.g., fillers of the present disclosure (present in a composition) have an average agglomerate size of less than 50 microns, such as less than 40 microns, such as less than 30 microns, such as less than 20 microns, such as less than 10 microns, such as less than 5 microns, such as less than 1 micron, such as less than 0.5 microns, such as less than 0.1 microns, based on a 1 cm×1 cm cross section of the ionomer as observed using scanning electron microscopy.

In some embodiments, the ionomer composition may include fillers and coloring agents. Exemplary materials include inorganic fillers such as calcium carbonate, clays, silica, talc, titanium dioxide or carbon black. Any type of carbon black can be used, such as channel blacks, furnace blacks, thermal blacks, acetylene black, lamp black and the like.

In some embodiments, the ionomer composition may include flame retardants, such as calcium carbonate, inorganic clays containing water of hydration such as aluminum trihydroxides (“ATH”) or Magnesium Hydroxide.

In some embodiments, the ionomer composition may include UV stabilizers, such as titanium dioxide or Tinuvin® XT-850. The UV stabilizers may be introduced into the composition as part of a masterbatch. For example, UV stabilizer may be pre-blended into a masterbatch with a thermoplastic resin, such as polypropylene, or a polyethylene, such as linear low density polyethylene.

Still other additives may include antioxidant and/or thermal stabilizers. In an exemplary embodiment, processing and/or field thermal stabilizers may include IRGANOX® B-225 and/or IRGANOX® 1010 available from BASF.

In some embodiments, the ionomer composition may include a polymeric processing additive. The processing additive may be a polymeric resin that has a very high melt flow index. These polymeric resins can include both linear and branched polymers that can have a melt flow rate that is about 500 dg/min or more, such as about 750 dg/min or more, such as about 1,000 dg/min or more, such as about 1,200 dg/min or more, such as about 1,500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives can include polypropylene homopolymers, and branched polymeric processing additives can include diene-modified polypropylene polymers.

In some embodiments, ionomer compositions of the present disclosure may optionally include reinforcing and non-reinforcing fillers, antioxidants, stabilizers, rubber processing oil, lubricants, antiblocking agents, anti-static agents, waxes, foaming agents, pigments, flame retardants, nucleating agents, and other processing aids known in the rubber compounding art. These additives can comprise up to about 50 weight percent of the total composition.

Fillers and extenders that can be utilized include conventional inorganics such as calcium carbonate, clays, silica, talc, titanium dioxide, carbon black, a nucleating agent, mica, wood flour, and the like, and blends thereof, as well as inorganic and organic nanoscopic fillers.

### Molded Products

The ionomers (or compositions thereof) described herein may be used to prepare molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion.

Further, the ionomers (or compositions thereof) described herein may be shaped into desirable end use articles by any suitable means. Suitable examples include thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof.

Thermoforming is a process of forming at least one pliable plastic sheet into a desired shape. Typically, an extrudate film of a composition (and any other layers or materials) is placed on a shuttle rack to hold it during heating. The shuttle rack indexes into the oven which pre-heats the film before forming. Once the film is heated, the shuttle rack indexes back to the forming tool. The film is then vacuumed onto the forming tool to hold it in place and the forming tool is closed. The tool stays closed to cool the film and the tool is then opened. The shaped laminate is then removed from the tool. The thermoforming is accomplished by vacuum, positive air pressure, plug-assisted vacuum forming, or combinations and variations of these, once the sheet of material reaches thermoforming temperatures, typically of 140° C. to 185° C. or higher. A pre-stretched bubble step is used, especially on large parts, to improve material distribution.

Blow molding is another suitable forming means for use with a composition, which includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, Concise Encyclopedia of Polymer Science and Engineering, pp. 90-92 (Jacqueline I. Kroschwitz, ed., John Wiley & Sons 1990).

Likewise, molded articles may be fabricated by injecting molten polymer into a mold that shapes and solidifies the molten polymer into desirable geometry and thickness of molded articles. Sheets may be made either by extruding a substantially flat profile from a die, onto a chill roll, or by calendaring.

### Non-Woven and Fiber Products

The ionomers (or compositions thereof) described herein may be used to prepare nonwoven fabrics and fibers in any suitable nonwoven fabric and fiber making process, including but not limited to, melt blowing, spunbonding, film aperturing, and staple fiber carding. Examples include continuous filament processes, spunbonding processes, and the like. The spunbonding process involves the extrusion of fibers through a spinneret. These fibers are then drawn using high velocity air and laid on an endless belt. A calendar roll is generally then used to heat the web and bond the fibers to one another although other techniques may be used such as sonic bonding and adhesive bonding.

The ionomers (or compositions thereof) according to embodiments disclosed herein are useful in a wide variety of applications, such as automotive overshoot parts (e.g., door handles and skins such as dashboard, instrument panel and interior door skins), airbag covers, toothbrush handles, shoe soles, grips, skins, toys, appliance moldings and fascia, gaskets, furniture moldings and the like.

Other articles of commerce that can be produced include but are not limited by the following examples: awnings and canopies—coated fabric, tents/tarps coated fabric covers, curtains extruded soft sheet, protective cloth coated fabric, bumper fascia, instrument panel and trim skin, coated fabric for auto interior, geo textiles, appliance door gaskets, liners/gaskets/mats, hose and tubing, syringe plunger tips, light weight conveyor belt PVC replacement, modifier for rubber concentrates to reduce viscosity, single ply roofing compositions, recreation and sporting goods, grips for pens, razors, toothbrushes, handles, and the like. Other articles include marine belting, pillow tanks, ducting, dunnage bags, architectural trim and molding, collapsible storage containers, synthetic wine corks, IV and fluid administration bags, examination gloves, and the like.

Exemplary articles made using the ionomers (or compositions thereof) include cookware, storage ware, toys, medical devices, sterilizable medical devices, sterilization containers, sheets, crates, containers, packaging, wire and cable jacketing, pipes, geomembranes, sporting equipment, chair mats, tubing, profiles, instrumentation sample holders and sample windows, outdoor furniture, e.g., garden furniture, playground equipment, automotive, boat and water craft components, and other such articles. In particular, the ionomers (or compositions thereof) are suitable for automotive components such as bumpers, grills, trim parts, dashboards and instrument panels, exterior door and hood components, spoiler, wind screen, hub caps, mirror housing, body panel, protective side molding, and other interior and external components associated with automobiles, trucks, boats, and other vehicles. The ionomers can be useful for producing “soft touch” grips in products such as personal care articles such as toothbrushes, etc.; toys; small appliances; packaging; kitchenware; sport and leisure products; consumer electronics; PVC and silicone rubber replacement medical tubing; industrial hoses; and shower tubing.

### Polymerization Processes

Polymerization processes to form the copolymers (and subsequent ionomers thereof) of the present disclosure can be carried out in any suitable manner. A homogeneous, bulk, or solution phase polymerization process can be used. Such processes can be run in a batch, semi-batch, or continuous mode. The polymerization process is typically a homogeneous polymerization process is defined to be a process where at least 90 wt % of the product is soluble in the reaction media. A bulk homogeneous process is particularly preferred. A bulk process is defined to be a process where monomer concentration in all feeds to the reactor is 70 vol % or more. Alternately, no solvent or diluent is present or added in the reaction medium, except for the small amounts used as the carrier for the catalyst system or other additives, or amounts typically found with the monomer; e.g., propane in propylene.

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the monomers and comonomers for the polymerization is 60 vol % solvent or less, such as 40 vol % or less, or such as 20 vol % or less, based on the total volume of the feedstream. In at least one embodiment, the polymerization is run in a bulk process.

Polymerizations can be run at any temperature and/or pressure suitable to obtain the desired polymers.

In some embodiments, hydrogen is present in the polymerization reactor at a partial pressure of 0.001 psig to 50 psig (0.007 kPa to 345 kPa), such as from 0.01 psig to 25 psig (0.07 kPa to 172 kPa), such as 0.1 psig to 10 psig (0.7 kPa to 70 kPa).

In at least one embodiment, the activity of the catalyst is at least 800 gpolymer/gcatalyst/hour, such as 1,000 or more gpolymer/gcatalyst/hour, such as 100 or more gpolymer/gcatalyst/hour, such as 1,600 or more gpolymer/gcatalyst/hour.

In at least one embodiment, little or no scavenger is used in the process to produce the copolymer. For example, scavenger (such as tri alkyl aluminum) is present at zero mol %, alternately the scavenger is present at a molar ratio of scavenger metal to transition metal of less than 100:1, such as less than 50:1, such as less than 15:1, such as less than 10:1.

In at least one embodiment, the polymerization can occur in one reaction zone. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone.

Copolymers of the present disclosure may be produced using processes where monomer (such as linear α-olefin), a metal alkenyl, optional comonomer, and optional diene, are contacted with a catalyst system comprising the result of the combination of an activator, and a catalyst compound. The catalyst compound and activator may be combined in any order, and are combined typically prior to contacting with the monomer, metal alkenyl, optional comonomer, and/or optional diene.

In at least one embodiment, a process to produce a copolymer can include a vinyl addition polymerization between α-olefins and metal alkenyls using a suitable catalyst system. In at least one embodiment, a metal alkenyl can be an alkenylaluminum, an alkenylborane, or any other suitable metal alkenyl, such as those comprising group 13 metals.

In at least one embodiment, metal alkenyl and solvent are mixed in a reactor. In at least one embodiment, a concentration of the metal alkenyl may be from about 0.001 mol % to about 20 mol %, such as from about 0.001 mol % to about 10 mol %, such as from about 0.01 mol % to about 5 mol %, based on total moles of monomer, metal alkenyl, optional comonomer, and optional diene.

In at least one embodiment, the solvent can be selected from straight and branched-chain hydrocarbons, cyclic and alicyclic hydrocarbons, perhalogenated hydrocarbons, aromatic and alkylsubstituted aromatic compounds, liquid olefins which may act as monomers or comonomers, aliphatic hydrocarbon solvents, and mixtures thereof.

In at least one embodiment, the reactor is equilibrated at a temperature of about 23° C. or greater, such as about 23° C. to about 190° C., such as from about 40° C. to about 100° C., such as from about 50° C. to about 90° C., such as from about 60° C. to about 80° C., such as from about 65° C. to about 75° C., such as about 70° C.

In at least one embodiment, an α-olefin monomer is added to the metal alkenyl and solvent mixture.

In at least one embodiment, one or more functionalizing/quenching agents is added to the reactor. Functionalizing/quenching agents can include, CO₂, CS₂, COS, O₂, H₂O, SO₂, SO₃, P₂O₅, NO₂, epoxides, cyclic anhydride, maleic anhydride, methyl methacrylate, styrene, air, and the like.

In at least one embodiment, a concentration of the α-olefin monomer may be from about 50 mol % to about 99.9 mol %, such as from about 60 mol % to about 99.9 mol %, such as from about 70 mol % to about 99.9 mol %, such as from about 80 mol % to about 99.5 mol %, such as from about 85 mol % to about 99 mol %, such as from about 90 mol % to about 99 mol %, such as from about 93 mol % to about 99 mol %, such as from about 95 mol % to about 99 mol %, based on total moles of monomer, metal alkenyl, optional comonomer, and optional diene.

In at least one embodiment, the reactor is pressurized with a comonomer, which is different than the α-olefin monomer. The comonomer can have any α-olefin composition or other comonomer composition provided herein.

In at least one embodiment, a concentration of the comonomer may be from about 1 mol % to about 99 mol %, such as from about 5 mol % to about 40 mol %, such as from about 10 mol % to about 35 mol %, such as from about 15 mol % to about 30 mol %, such as from about 20 mol % to about 30 mol %, such as from about 25 mol % to about 30 mol %, based on total moles of monomer, metal alkenyl, optional comonomer, and optional diene.

Monomers and optional comonomers independently include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer comprising one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups. In another embodiment, the monomer includes propylene and an optional comonomer comprising one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers may include ethylene, propylene, butene, pentene, hexene, heptene, octene, nonene, decene, undecene, dodecene, norbornene, dicyclopentadiene, cyclopentene, cycloheptene, cyclooctene, cyclododecene, 7-oxanorbornene, substituted derivatives thereof, and isomers thereof, such as hexene, heptene, octene, nonene, decene, dodecene, cyclooctene, 1-hydroxy-4-cyclooctene, 1-acetoxy-4-cyclooctene, 5-methylcyclopentene, cyclopentene, norbornene, and their respective homologs and derivatives, such as norbornene.

In at least one embodiment, an α-olefin monomer or comonomer can be a linear α-olefin. Linear α-olefins (LAOs) can be substituted or unsubstituted C₆-C₆₀ LAOs, such as C₆-C₅₀ LAOs, such as C₈-C₄₀ LAOs, such as C₁₀-C₃₀ LAOs, such as C₁₀-C₂₀ LAOs, such as C₁₅-C₂₀ LAOs, alternatively C₈-C₁₆ LAOs, such as C₈-C₁₂ LAOs. In at least one embodiment, a copolymer has linear α-olefin units selected from 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-icosene, 1-henicosene, 1-docosene, 1-tricosene, 1-tetracosene, 1-pentacosene, and combination(s) thereof.

In at least one embodiment, a diene is optionally added to the reactant mixture. Addition of a diene to the copolymer can result in formation of ionomers having increased toughness compared to ionomers formed using similar polymers without diene units. In at least one embodiment, dienes can be substituted or unsubstituted dienes selected from C₄-C₆₉ dienes, such as C₅-050 dienes, such as C₅-C₄₀ dienes, such as C₅-C₃₀ dienes, such as C₅-C₂₀ dienes, such as C₆-C₁₅ dienes, such as C₆-C₁₀ dienes, such as C₇-C₉ dienes, such as a substituted or unsubstituted C₇ diene, C₈ diene, or C₉ diene. In at least one embodiment, a copolymer has diene units of a C₇ diene. In at least one embodiment, a diene is a substituted or unsubstituted α,Ω-diene (e.g., the diene units of the copolymer are formed from di-vinyl monomers). The dienes can be linear di-vinyl monomers. In at least one embodiment, a diene is selected from butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and combination(s) thereof. In some embodiments, a diene is selected from 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and combination(s) thereof. In at least one embodiment, a diene is selected from cyclopentadiene, vinylnorbornene, norbomadiene, 5-ethylidene-2-norbornene, 5-vinyl-2-norbornene, divinylbenzene, dicyclopentadiene, and combination(s) thereof. In at least one embodiment, an ionomer has diene units of 5-ethylidene-2-norbornene.

In at least one embodiment, a concentration of the optional diene added to the reaction mixture may be from about 0.1 mol % to about 40 mol %, such as from about 0.1 mol % to about 20 mol %, such as from about 1 mol % to about 10 mol %, based on total moles of monomer, metal alkenyl, optional comonomer, and diene, such as from about 1 mol % to about 5 mol %. In some other embodiments, 500 ppm or less of diene is added to the polymerization, such as 400 ppm or less, such as 300 ppm or less. In other embodiments, at least 50 ppm of diene is added to the polymerization, or 100 ppm or more, or 150 ppm or more.

In at least one embodiment, monomer, metal alkenyl, optional comonomer, and optional diene are charged to the reactor at a pressure independently selected from about 10 psig or greater, such as from about 10 psig to about 500 psig, such as from about 50 psig to about 200 psig, such as from about 80 psig to about 150 psig, such as about 100 psig, alternatively about 120 psig.

In at least one embodiment, the monomer α-olefin is ethylene or propylene.

In at least one embodiment, the α-olefin monomer is selected from the group consisting of C₃-C₆₀ α-olefins, and the comonomer is ethylene.

In at least one embodiment, the α-olefin monomer is selected from the group consisting of C₂ and C₄-C₆₀ α-olefins, and the comonomer is propylene. Addition of longer chain α-olefins to the copolymer can result in formation of ionomers having unentangled backbones for soft materials and better processing properties.

In at least one embodiment, the reactant mixture is stirred rapidly during polymerization.

In at least one embodiment, a suitable activator is dissolved in hydrocarbon solvent, such as hexane or toluene, and added to the mixture. The activator can have any activator composition provided herein.

In at least one embodiment, polymerization proceeds for about 5 minutes or greater, such as about 5 minutes to about 60 minutes, such as about 5 minutes to about 30 minutes, such as from about 10 minutes to 20 minutes, such as about 15 minutes.

In at least one embodiment, an oxidizing agent is added to the reactor. In at least one embodiment an oxidizing agent can include CO₂, CS₂, COS, SO₃, and combination(s) thereof.

In at least one embodiment, the oxidizing agent is charged to the reactor at a pressure of about 0.5 psig or greater, such as from about 0.5 psig to about 500 psig, such as from about 50 psig to about 200 psig, such as from about 80 psig to about 150 psig, such as about 100 psig.

In at least one embodiment, oxidation proceeds at a reactor temperature of about 23° C. or greater, such as 23° C. to about 150° C., such as from about 40° C. to about 100° C., such as from about 50° C. to about 90° C., such as from about 60° C. to about 80° C., such as from about 65° C. to about 75° C., such as about 70° C.

In at least one embodiment, oxidation proceeds for about 5 minutes or greater, such as about 5 minutes to about 60 minutes, such as about 5 minutes to about 30 minutes, such as from about 10 minutes to 20 minutes, such as about 15 minutes.

In at least one embodiment, total reaction time is about 10 minutes or greater, such as from about 10 minutes to about 60 minutes, such as from about 20 minutes to about 40 minutes, such as about 30 minutes.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Useful chain transfer agents are typically alkylalumoxanes, a compound represented by the formula AlR₃, ZnR₂ (where each R is, independently, a C₁-C₈ aliphatic radical, such as methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof.

### Solution Polymerization

In at least one embodiment, the polymerization process with catalyst compounds of the present disclosure is a solution polymerization process.

A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are not turbid as described in J. Vladimir Oliveira, et al. (2000) Ind. Eng, Chem. Res., v.29, pg. 4627. Solution polymerization may involve polymerization in a continuous reactor in which the polymer formed, the starting monomer and catalyst materials supplied are agitated to reduce or avoid concentration gradients and in which the monomer acts as a diluent or solvent or in which a hydrocarbon is used as a diluent or solvent. Suitable processes can operate at temperatures from about 0° C. to about 250° C., such as from about 50° C. to about 170° C., such as from about 80° C. to about 150° C., such as from about 100° C. to about 140° C., and/or at pressures of about 0.1 MPa or more, such as 2 MPa or more. The upper pressure limit is not critically constrained but can be about 200 MPa or less, such as 120 MPa or less, such as 30 MPa or less. Temperature control in the reactor can generally be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

A process described herein can be a solution polymerization process that may be performed in a batchwise fashion (e.g., batch; semi-batch) or in a continuous process. Suitable reactors may include tank, loop, and tube designs. In at least one embodiment, the process is performed in a continuous fashion and dual loop reactors in a series configuration are used. In at least one embodiment, the process is performed in a continuous fashion and dual continuous stirred-tank reactors (CSTRs) in a series configuration are used. Furthermore, the process can be performed in a continuous fashion and a tube reactor can be used. In another embodiment, the process is performed in a continuous fashion and one loop reactor and one CSTR are used in a series configuration. The process can also be performed in a batchwise fashion and a single stirred tank reactor can be used.

### Polymerization Catalysts

Suitable polymerization catalysts can include any one or more metallocenes, half-metallocenes, and post metallocenes as well as any other catalyst capable of incorporating metal vinyls, including bis(phenolate) heterocyclic Lewis Base Complexes. Suitable catalysts and catalyst systems are shown and described in U.S. Pat. No. 9,796,795; WO 2017/192226; US 2020/0255555; US 2020/0254431; US 2020/0255556; WO 2020/167819; WO 2020/167824; and WO 2020/167838, which are incorporated by reference herein.

Useful metallocene catalyst compounds, for example, can be transition metal catalyst compounds having one, two or three, typically one or two, substituted or unsubstituted cyclopentadienyl ligands (such as substituted or unsubstituted Cp, Ind or Flu) bound to the transition metal. Metallocene catalyst compounds as used herein include metallocenes comprising Group 3 to Group 12 metal complexes, such as, Group 4 to Group 6 metal complexes, for example, Group 4 metal complexes.

The metallocene catalyst compounds may be unbridged or bridged metallocene catalyst compounds represented by the formula (MCN-I): Cp^{A}Cp^{B}M′X′ₙ, or (MCN-II): Cp^{A}(T)Cp^{B}M′X′ₙ, wherein each Cp^{A} and Cp^{B} is independently selected from cyclopentadienyl ligands (for example, Cp, Ind, or Flu) and ligands isolobal to cyclopentadienyl, one or both Cp^{A} and Cp^{B} may contain heteroatoms, and one or both Cp^{A} and Cp^{B} may be substituted by one or more R″ groups; M′ is selected from Groups 3 through 12 atoms and lanthanide Group atoms; X′ is an anionic leaving group; n is 0 or an integer from 1 to 4; each R″ is independently selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, ether, and thioether; and (T) is a bridging group selected from divalent alkyl, divalent substituted alkyl, divalent heteroalkyl, divalent alkenyl, divalent substituted alkenyl, divalent heteroalkenyl, divalent alkynyl, divalent substituted alkynyl, divalent heteroalkynyl, divalent alkoxy, divalent aryloxy, divalent alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether.

In at least one embodiment, each of Cp^{A} and Cp^{B} is independently selected from cyclopentadienyl, indenyl, fluorenyl, cyclopentaphenanthreneyl, benzindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated, and substituted versions thereof, preferably cyclopentadienyl, n-propylcyclopentadienyl, indenyl, pentamethylcyclopentadienyl, tetramethylcyclopentadienyl, and n-butylcyclopentadienyl, 2-methyl-4-phenyl-1H-indene, 2-methyl-7-phenyl-1H-indene, 4-(4-(tert-butyl)phenyl)-2-methyl-1H-indene, 7-(4-(tert-butyl)phenyl)-2-methyl-1H-indene,2-methyl-4-(o-tolyl)-1H-indene, 2-methyl-7-(o-tolyl)-1H-indene,4-(3,5-dimethylphenyl)-2-methyl-1H-indene, 7-(3,5-dimethylphenyl)-2-methyl-1H-indene,4-(3,5-di-tert-butylphenyl)-2-methyl-1H-indene,7-(3,5-di-tert-butylphenyl)-2-methyl-1H-indene, 4-(3,5-di-tert-butyl-4-methoxyphenyl)-2-methyl-1H-indene,7-(3,5-di-tert-butyl-4-methoxyphenyl)-2-methyl-1H-indene, 4-([1,1′-biphenyl]-2-yl)-2-methyl-1H-indene,7-([1,1′-biphenyl]-2-yl)-2-methyl-1H-indene, 2-methyl-4-(2,4,5-trimethylphenyl)-1H-indene,2-methyl-7-(2,4,5-trimethylphenyl)-1H-indene, 1-(2-methyl-1H-inden-4-yl)naphthalene, 1-(2-methyl-1H-inden-7-yl)naphthalene,9-(2-methyl-1H-inden-4-yl)anthracene, 9-(2-methyl-1H-inden-7-yl)anthracene,4-(3,5-bis(trifluoromethyl)phenyl)-2-methyl-1H-indene, 7-(3,5-bis(trifluoromethyl)phenyl)-2-methyl-1H-indene,6-methyl-1,2,3,5-tetrahydro-s-indacene, 6-methyl-8-phenyl-1,2,3,5-tetrahydro-s-indacene,6-methyl-4-phenyl-1,2,3,5-tetrahydro-s-indacene, 8-(4-(tert-butyl)phenyl)-6-methyl-1,2,3,5-tetrahydro-s-indacene,4-(4-(tert-butyl)phenyl)-6-methyl-1,2,3,5-tetrahydro-s-indacene, 8-(2-isopropylphenyl)-6-methyl-1,2,3,5-tetrahydro-s-indacene,4-(2-isopropylphenyl)-6-methyl-1,2,3,5-tetrahydro-s-indacene, 6-methyl-8-(o-tolyl)-1,2,3,5-tetrahydro-s-indacene,6-methyl-4-(o-tolyl)-1,2,3,5-tetrahydro-s-indacene, 8-([1,1′-biphenyl]-2-yl)-6-methyl-1,2,3,5-tetrahydro-s-indacene,4-([1,1′-biphenyl]-2-yl)-6-methyl-1,2,3,5-tetrahydro-s- indacene, 8-(3,5-di-tert-butyl-4-methoxyphenyl)-6-methyl-1,2,3,5-tetrahydro-s-indacene, 4-(3,5-di-tert-butyl-4-methoxyphenyl)-6-methyl-1,2,3,5-tetrahydro-s-indacene, 8-(3,5-di-tert-butylphenyl)-6-methyl-1,2,3,5-tetrahydro-s-indacene,4-(3,5-di-tert-butylphenyl)-6-methyl-1,2,3,5-tetrahydro-s-indacene, 8-(3,5-bis(trifluoromethyl)phenyl)-6-methyl-1,2,3,5-tetrahydro-s-indacene, 4-(3,5-bis(trifluoromethyl)phenyl)-6-methyl-1,2,3,5-tetrahydro-s-indacene, 6-methyl-8-(naphthalen-1-yl)-1,2,3,5-tetrahydro-s-indacene,6-methyl-4-(naphthalen-1-yl)-1,2,3,5-tetrahydro-s-indacene, 9-(6-methyl-1,2,3,7-tetrahydro-s-indacen-4-yl)anthracene,9-(6-methyl-1,2,3,5-tetrahydro-s-indacen-4-yl)anthracene, 6-methyl-8-(2,4,5-trimethylphenyl)-1,2,3,5-tetrahydro-s-indacene,4-methyl-8-(2,4,5-trimethylphenyl)-1,2,3,5-tetrahydro-s-indacene.

In at least one embodiment, each Cp^{A} and Cp^{B} may independently be indacenyl, tetrahydroindenyl, tetrahydroindacenyl.

In at least one embodiment, (T) is a bridging group containing at least one Group 13, 14, 15, or 16 element, in particular boron or a Group 14, 15 or 16 element, preferably (T) is O, S, NR′, or SiR′₂, where each R′ is independently hydrogen or C₁-C₂₀ hydrocarbyl.

Other suitable polymerization catalysts for forming the α-olefin-metal alkenyl and α-olefin-metal alkenyl-diene copolymers provided herein can also include monocyclopentadienyl group 4 transition metal compounds represented by the formula:

T_{y}Cp′ₘMGₙX_{q}

wherein Cp′ is a tetrahydroindacenyl group (such as tetrahydro-s-indacenyl or tetrahydro-as-indacenyl) which may be substituted or unsubstituted, provided that when Cp′ is tetrahydro-s-indecenyl:
1) the 3 and/or 4 positions are not aryl or substituted aryl,
2) the 3 position is not directly bonded to a group 15 or 16 heteroatom,
3) there are no additional rings fused to the tetrahydroindacenyl ligand,
4) T is not bonded to the 2-position,
5) the 5, 6, or 7-position (such as the 6 position) is geminally disubstituted, such as with two C₁-C₁₀ alkyl groups; and such as
6) when G is t-butylamido, adamantylamido, cyclooctylamido, cyclohexylamido or cyclododecylamido and the 5 and 7 positions are H, then the 6 position and/or X is not methyl;
M is a group 3, 4, 5, or 6 transition metal, such as group 4 transition metal, for example titanium, zirconium, or hafnium (such as titanium); G is a heteroatom group represented by the formula JRⁱ_{z} where J is N, P, O or S, Rⁱ is a C₁ to C₂₀ hydrocarbyl group, and z is 2−y when J is N or P, and 1−y when J is O or S (such as J is N and z is 1); T is a bridging group (such as dialkylsilylene or dialkylcarbylene); T can be (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure, and in a particular embodiment, R⁸ and R⁹ are not aryl); y is 0 or 1, indicating the absence or presence of T; X is a leaving group (such as a halide, a hydride, an alkyl group, an alkenyl group or an arylalkyl group); m=1; n=1, 2 or 3; q=1, 2 or 3; and the sum of m+n+q is equal to the oxidation state of the transition metal (such as 3, 4, 5, or 6, such as 4); such as m=1, n=1, q is 2, and y=1.

A catalyst system can include an activator, and at least one metallocene catalyst compound, where the metallocene is a tetrahydroindacenyl group 4 transition metal compound, such as represented by the formula:

T_{y}Cp′ₘMGₙX_{q}

wherein Cp′ is a tetrahydroindacenyl group (such as tetrahydro-s-indacenyl or tetrahydro-as-indacenyl) which may be substituted or unsubstituted, provided that when Cp′ is tetrahydro-s-indecenyl:
1) the 3 and/or 4 positions are not aryl or substituted aryl,
2) the 3 position is not directly bonded to a group 15 or 16 heteroatom,
3) there are no additional rings fused to the tetrahydroindacenyl ligand,
4) T is not bonded to the 2-position, and
5) the 5, 6, or 7-position (such as the 6 position) is geminally disubstituted, such as with two C₁-C₁₀ alkyl groups;
M is a group 3, 4, 5, or 6 transition metal, preferably group 4 transition metal, for example titanium, zirconium, or hafnium (such as titanium);
G is a heteroatom group represented by the formula JRⁱ_{z} where J is N, P, O or S, Rⁱ is a C₁ to C₂₀ hydrocarbyl group (alternately a C₂ to C₂₀ hydrocarbyl group), and z is 2−y when J is N or P, and 1−y when J is O or S (such as J is N and z is 1);
T is a bridging group (such as dialkylsilylene or dialkylcarbylene);
T is preferably (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure, and in a particular embodiment, R⁸ and R⁹ are not aryl);
y is 0 or 1, indicating the absence or presence of T; X is a leaving group (such as a halide, a hydride, an alkyl group, an alkenyl group or an arylalkyl group);
m=1; n=1, 2 or 3; q=1, 2, or 3; and the sum of m+n+q is equal to the oxidation state of the transition metal (such as 3, 4, 5, or 6, such as 4); such as m=1, n=1, q is 2, and y=1.

In some embodiments, the 6 position is not methyl.

In at least one embodiment, each Rⁱ is a linear, branched or cyclic C₁ to C₂₀ hydrocarbyl group, such as independently selected from the group consisting of methyl, ethyl, propyl, butyl, pentyl, hexyl, heptyl, octyl, nonyl, decyl, and isomers thereof, such as t-butyl and or cyclododecyl.

In at least one embodiment, a mono-tetrahydro-s-indacenyl group 4 transition metal compound is represented by the Formula (I) or (II):

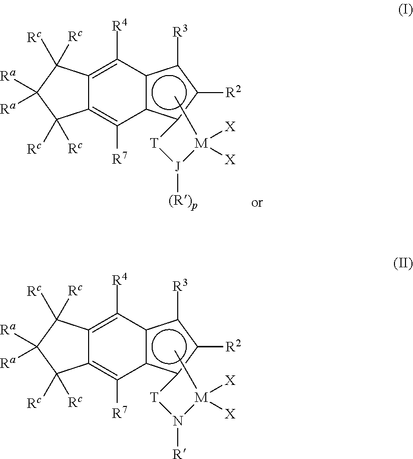

where
M is a group 4 metal (such as Hf, Ti or Zr, such as Ti);
J is N, O, S or P (such as N and p=1);
p is 1 when J is N or P, and is 0 when J is O or S;
each R^{a} is independently C₁-C₁₀ alkyl (alternately a C₂-C₁₀ alkyl);
each R^{c} is independently hydrogen or a C₁-C₁₀ alkyl;
each R², R³, R⁴, and R⁷ is independently hydrogen, or a C₁-C₅₀ substituted or unsubstituted hydrocarbyl, halocarbyl, silylcarbyl or germylcarbyl, provided that:
1) R³ and/or R⁴ are not aryl or substituted aryl,
2) R³ is not directly bonded to a group 15 or 16 heteroatom, and
3) adjacent R⁴, R^{c}, R^{a} or R⁷ do not join together to form a fused ring system;
each R′ is, independently, a C₁-C₁₀₀ substituted or unsubstituted hydrocarbyl, halocarbyl, silylcarbyl or germylcarbyl; T is (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure;
each X is, independently, a leaving group, or two Xs are joined and bound to the metal atom to form a metallocycle ring, or two Xs are joined to form a chelating ligand, a diene ligand, or an alkylidene, such as provided that: in Formula (I), when J(R′)p is t-butylamido, adamantylamido, cyclooctylamido, cyclohexylamido or cyclododecylamido and R^{c} are H, then R^{a} and or X is not methyl; and in Formula (II), when JR′ is t-butylamido, adamantylamido, cyclooctylamido, cyclohexylamido or cyclododecylamido and R^{c} is H, then R^{a} and/or X is not methyl.

Optionally, R^{a} is not methyl.

In at least one embodiment, a bridged mono-tetrahydro-as-indacenyl transition metal compound is represented by the Formula (III) or (IV):

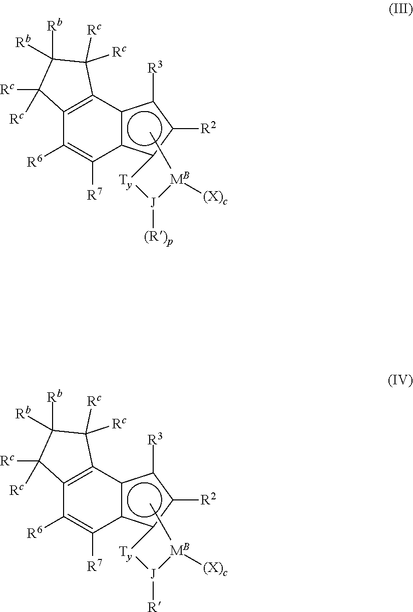

where
M is group 3, 4, 5, or 6 transition metal;
B is the oxidation state of M, and is 3, 4, 5 or 6;
c is B−2;
J is N, O, S or P;
p is 2−y when J is N or P, and 1−y when J is O or S;
each R², R³, R⁶, and R⁷, is independently hydrogen, or a C₁-C₅₀ substituted or unsubstituted hydrocarbyl, halocarbyl or silylcarbyl;
each R^{b} and R^{c} is independently C₁-C₁₀ alkyl, or hydrogen;
each R′ is, independently, a C₁-C₁₀₀ substituted or unsubstituted hydrocarbyl, halocarbyl, silylcarbyl or germycarbyl;
T is (CR⁸R⁹)ₓ, SiR⁸R⁹ or GeR⁸R⁹ where x is 1 or 2, R⁸ and R⁹ are independently selected from hydrogen, substituted or unsubstituted hydrocarbyl, halocarbyl, silylcarbyl and germylcarbyl, and R⁸ and R⁹ may optionally be bonded together to form a ring structure;
y is 1 when T is present and y is 0 when T is absent; and
each X is, independently, a leaving group, or two Xs are joined and bound to the metal atom to form a metallocycle ring, or two Xs are joined to form a chelating ligand, a diene ligand, or an alkylidene.

In at least one embodiment, a bridged mono-tetrahydro-as-indacenyl transition metal compound is represented by the Formula (A) or (B):

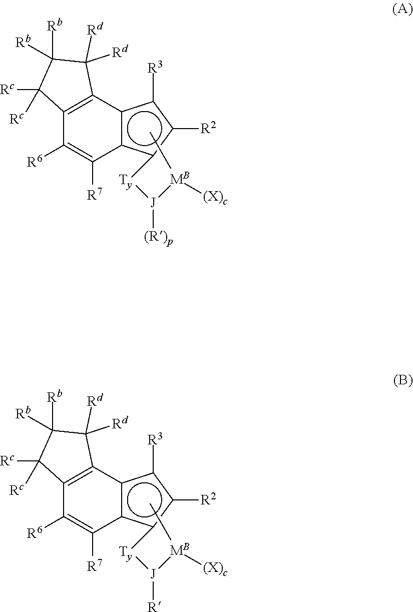

where M, B, c, J, p, R², R³, R⁶, R⁷, R′, T, y and X are as defined above for Formula (III) and (IV) and each R^{b} , R^{c}, and R^{d} is independently C₁-C₁₀ alkyl, or hydrogen, provided that both R^{b} , both R^{c}, or both R^{d} are not hydrogen. In some embodiments, R^{d} is independently selected from the group consisting of hydrogen, methyl, ethyl, propyl, butyl, pentyl, hexyl, heptyl, octyl, nonyl, decyl, and isomers thereof, such as hydrogen or methyl.

The present disclosure also relates to bridged monoindacenyl group 4 transition metal compounds represented by the Formula (V) or (VI):

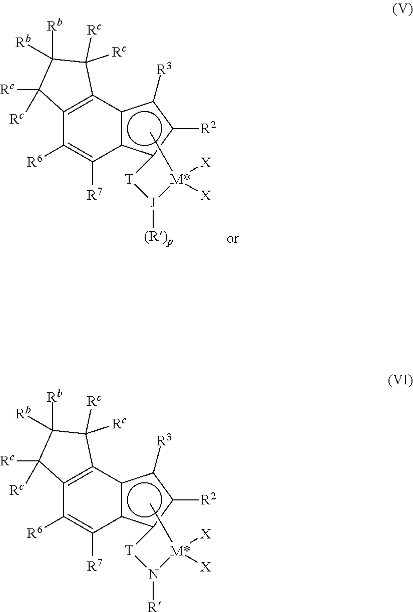

where
M* is a group 4 transition metal (such as Hf, Zr or Ti);
J is N, O, S or P (such as J is N and p is 1);
p is 2−y when J is N or P, and 1−y when J is O or S,
each R², R³, R⁶, and R⁷ is independently hydrogen, or a C₁-C₅₀ substituted or unsubstituted hydrocarbyl, halocarbyl, silylcarbyl or germylcarbyl;
each R^{b} and each R^{c} is independently a C₁-C₁₀ alkyl or hydrogen;
each R′ is, independently, a C₁-C₁₀₀ substituted or unsubstituted hydrocarbyl, halocarbyl, silylcarbyl or germylcarbyl;
T is (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure;
y is 1 when T is present and y is 0 when T is absent; and
each X is, independently, a leaving group, or two Xs are joined and bound to the metal atom to form a metallocycle ring, or two Xs are joined to form a chelating ligand, a diene ligand, or an alkylidene.

In a particularly useful embodiment of Formula (V) and/or (VI), M* is a group 4 metal (such as Hf, Zr or Ti); J is nitrogen; each R², R³, R⁶, and R⁷ is independently hydrogen, or a C₁-C₂₀ substituted or unsubstituted hydrocarbyl, halocarbyl, silylcarbyl or germycarbyl; each R^{b} and each R^{c} is independently C₁-C₁₀ alkyl (such as methyl, ethyl, propyl, butyl, pentyl, hexyl, heptyl, octyl, nonyl, decyl, or an isomer thereof), or hydrogen; R′ is a C₁-C₂₀ substituted or unsubstituted hydrocarbyl, halocarbyl, silylcarbyl or germylcarbyl; T is (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl, y is 1, and R⁸ and R⁹ may optionally be bonded together to form a ring structure; each X is halogen or a C₁ to C₂₀ hydrocarbyl wherein the hydrocarbyls are optionally joined to form a chelating ligand, a diene, or an alkylidene.

In at least one embodiment, M and/or M* are a group 4 metal, such as titanium.

In at least one embodiment, R³ is not substituted with a group 15 or 16 heteroatom.

In at least one embodiment, each R², R³, R⁴, R⁶, and R⁷ is independently hydrogen, or a C₁-C₅₀ substituted or unsubstituted hydrocarbyl, halocarbyl, silylcarbyl or germylcarbyl, such as methyl, ethyl, propyl, butyl, pentyl, hexyl, heptyl, octyl, nonyl, decyl, undecyl, and dodecyl or an isomer thereof.

In at least one embodiment, each R^{a} is independently selected from the group consisting of methyl, ethyl, propyl, butyl, pentyl, hexyl, heptyl, octyl, nonyl, decyl, and isomers thereof, such as methyl and ethyl, such as methyl.

Alternately, the indacene ligand does not have a methyl at the 6 position, alternately one or both R^{a} are not methyl.

In at least one embodiment, R^{b} is independently selected from the group consisting of hydrogen, methyl, ethyl, propyl, butyl, pentyl, hexyl, heptyl, octyl, nonyl, decyl, and isomers thereof, such as methyl and ethyl, such as methyl.

In at least one embodiment, R^{c} is independently selected from the group consisting of hydrogen, methyl, ethyl, propyl, butyl, pentyl, hexyl, heptyl, octyl, nonyl, decyl, and isomers thereof, such as hydrogen or methyl.

In at least one embodiment, R′ is a C₁-C₁₀₀ substituted or unsubstituted hydrocarbyl, halocarbyl, or silylcarbyl, such as methyl, ethyl, propyl, butyl, pentyl, hexyl, heptyl, octyl, nonyl, decyl, undecyl, dodecyl or an isomer thereof, such as t-butyl, neopentyl, cyclohexyl, cyclooctyl, cyclododecyl, adamantyl, or norbomyl.

In at least one embodiment, T is CR⁸R⁹, R⁸R⁹C—CR⁸R⁹, SiR⁸R⁹ or GeR^{8*}R^{9*} where R⁸ and R⁹ are independently selected from substituted or unsubstituted hydrocarbyl, io halocarbyl, silylcarbyl and R⁸ and R⁹ may optionally be bonded together to form a ring structure, such as each R⁸ and R⁹ is independently methyl, ethyl, propyl, butyl, pentyl, hexyl, heptyl, octyl, nonyl, decyl, benzyl, phenyl, methylphenyl or an isomer thereof, such as methyl, ethyl, propyl, butyl, or hexyl.

In at least one embodiment, at least one of R⁸ or R⁹ is not aryl. In at least one embodiment, R⁸ is not aryl. In at least one embodiment, R⁹ is not aryl. In at least one embodiment, R⁸ and R⁹ are not aryl.

In at least one embodiment, R⁸ and R⁹ are independently C₁-C₁₀ alkyls, such as methyl, ethyl, propyl, butyl, pentyl, hexyl, heptyl, octyl, nonyl, decyl, or an isomer thereof.

In at least one embodiment, each R², R³, R⁴, and R⁷ is independently hydrogen or hydrocarbyl. In at least one embodiment, each R², R³, R⁶, and R⁷ is independently hydrogen or hydrocarbyl.

In at least one embodiment, each R², R³, R⁴, and R⁷ is independently hydrogen or a C₁-C₁₀ alkyl, such as methyl, ethyl, propyl, butyl, pentyl, hexyl, heptyl, octyl, nonyl, decyl, or an isomer thereof.

In at least one embodiment, each R², R³, R⁶, and R⁷ is independently hydrogen or a C₁-C₁₀ alkyl, such as methyl, ethyl, propyl, butyl, pentyl, hexyl, heptyl, octyl, nonyl, decyl, or an isomer thereof.

In at least one embodiment, R² is a C₁-C₁₀ alkyl and R³, R⁴, and R⁶ are hydrogen. In some embodiments, R² is a C₁-C₁₀ alkyl and R³, R⁶, and R⁷ are hydrogen.

In at least one embodiment, R², R³, R⁴, and R⁶ are hydrogen. In some embodiments, R², R³, R⁶, and R⁷ are hydrogen.

In at least one embodiment, R² is methyl, ethyl, or an isomer of propyl, butyl, pentyl or hexyl, and R³, R⁴, and R⁷ are hydrogen. In at least one embodiment, R² is methyl, ethyl, or an isomer of propyl, butyl, pentyl or hexyl, and R³, R⁶, and R⁷ are hydrogen.

In at least one embodiment, R² is methyl and R³, R⁴, and R⁷ are hydrogen. In some embodiments, R² is methyl and R³, R⁶, and R⁷ are hydrogen.

In at least one embodiment, R³ is hydrogen. In at least one embodiment, R² is hydrogen. In at least one embodiment, R′ is C₁-C₁₀₀ or C₁-C₃₀ substituted or unsubstituted hydrocarbyl.

In at least one embodiment, R′ is C₁-C₃₀ substituted or unsubstituted alkyl (linear, branched, or cyclic), aryl, alkaryl, or heterocyclic group.

In at least one embodiment, R′ is C₁-C₃₀ linear, branched or cyclic alkyl group. In at least one embodiment, R′ is methyl, ethyl, or any isomer of propyl, butyl, pentyl, hexyl, io heptyl, octyl, nonyl, decyl, undecyl, or dodecyl.

In at least one embodiment, R′ is a cyclic or polycyclic hydrocarbyl. In at least one embodiment, R′ is selected from tert-butyl, neopentyl, cyclohexyl, cycloheptyl, cyclooctyl, cyclononyl, cyclodecyl, cycloundecyl, cyclododecyl, adamantyl, and norbornyl.

In at least one embodiment, Rⁱ is selected from tert-butyl, neopentyl, cyclohexyl, cycloheptyl, cyclooctyl, cyclononyl, cyclodecyl, cycloundecyl, cyclododecyl, adamantyl, and norbornyl.

In at least one embodiment, T is selected from diphenylmethylene, dimethylmethylene, 1,2-ethylene, cyclotrimethylenesilylene, cyclotetramethylenesilylene, cyclopentamethylenesilylene, dimethylsilylene, diethylsilylene, methylethylsilylene, and dipropylsilylene.

In at least one embodiment, each R^{a} is independently methyl, ethyl, propyl, butyl, pentyl or hexyl.

In at least one embodiment, each R^{a} is independently methyl or ethyl. In at least one embodiment, each R^{a} is methyl.

In at least one embodiment, each R^{b} is independently hydrogen, methyl, ethyl, propyl, butyl, pentyl or hexyl. In at least one embodiment, each R^{b} and each R^{c} is independently hydrogen, methyl, ethyl, propyl, butyl, pentyl or hexyl. In at least one embodiment, each R^{b} is independently hydrogen, methyl or ethyl. In at least one embodiment, each R^{b} is methyl.

In at least one embodiment, each X is hydrocarbyl, halocarbyl, or substituted hydrocarbyl or halocarbyl. In at least one embodiment, X is methyl, benzyl, or halo where halo includes fluoro, chloro, bromo and iodido.

In at least one embodiment of Formula (I) or (II) described herein:
1) R³ and/or R⁴ are not aryl or substituted aryl,
2) R³ is not directly bonded to a group 15 or 16 heteroatom, and
3) adjacent R⁴, R^{c}, R^{a} or R⁷ do not join together to form a fused ring system, and
4) each R^{a} is a C₁ to C₁₀ alkyl (such as methyl, ethyl, propyl, butyl, pentyl, hexyl, heptyl, octyl, nonyl, decyl, or an isomer thereof).

Useful catalysts also include compounds represented by the Formula (VII):

T_{y}Cp′ₘMGₙX_{q}

wherein Cp′ is a tetrahydroindacenyl group (such as tetrahydro-s-indacenyl or tetrahydro-as-indacenyl) which may be substituted or unsubstituted, provided that when Cp′ is tetrahydro-s-indecenyl:
1) the 3 and/or 4 positions are not aryl or substituted aryl,
2) the 3 position is not directly bonded to a group 15 or 16 heteroatom,
3) there are no additional rings fused to the tetrahydroindacenyl ligand,
4) T is not bonded to the 2-position, and
5) the 5, 6, or 7-position (such as the 6 position) is geminally disubstituted, such as with two C₁-C₁₀ alkyl groups;
M is a group 3, 4, 5, or 6 transition metal, preferably group 4 transition metal, for example titanium, zirconium, or hafnium (such as titanium);
G is a heteroatom group represented by the formula JRⁱ _{z} where J is N, P, O or S, Rⁱ is a C₁ to C₂₀ hydrocarbyl group, and z is 2−y when J is N or P, and 1−y when J is O or S (such as J is N and z is 1);
T is a bridging group (such as dialkylsilylene or dialkylcarbylene); T is preferably (CR⁸R⁹)ₓ, SiR⁸R⁹ or GeR⁸R⁹ where x is 1 or 2, R⁸ and R⁹ are independently selected from substituted or unsubstituted hydrocarbyl, halocarbyl, silylcarbyl and germylcarbyl and R⁸ and R⁹ may optionally be bonded together to form a ring structure, and in a particular embodiment, R⁸ and R⁹ are not aryl);
y is 0 or 1, indicating the absence or presence of T;
X is a leaving group (such as a halide, a hydride, an alkyl group, an alkenyl group or an arylalkyl group);
m=1; n=1, 2 or 3; q=1, 2 or 3; and the sum of m+n+q is equal to the oxidation state of the transition metal (such as 3, 4, 5, or 6, such as 4); such as m=1, n=1, q is 2, and y=1.

In at least one embodiment of Formula (VII) described herein, M is a Group 4 transition metal (such as Hf, Ti and/or Zr, such as Ti).

In at least one embodiment of Formula (VII) described herein, J is N, and Rⁱ is a linear branched or cyclic hydrocarbyl group having from one to twenty carbon atoms (such as methyl, ethyl, propyl, butyl, pentyl, hexyl, heptyl, octyl, nonyl, decyl, undecyl, dodecyl, or an isomer thereof, including t-butyl, cyclododecyl, cyclooctyl or an isomer thereof) and z is 1 or 2, such as 1, and JRⁱ_{z} is cyclododecyl amido, t-butyl amido, and or 1-adamantyl amido.

In at least one embodiment of Formula (VII) described herein, each X may be, independently, a halide, a hydride, an alkyl group, an alkenyl group or an arylalkyl group.

Alternately, in at least one embodiment of Formula (VII), each Xis, independently, selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two X's may form a part of a fused ring or a ring system), such as each X is independently selected from halides, aryls and C₁ to C₅ alkyl groups, such as each X is a phenyl, methyl, ethyl, propyl, butyl, pentyl, or chloro group.

In at least one embodiment of Formula (VII) described herein, the Cp′ group may be substituted with a combination of substituent groups R. Non-limiting examples of substituent groups R include one or more from the group selected from hydrogen, or linear, branched alkyl radicals, or alkenyl radicals, alkynyl radicals, cycloalkyl radicals or aryl radicals, acyl radicals, alkoxy radicals, aryloxy radicals, alkylthio radicals, dialkylamino radicals, alkoxycarbonyl radicals, aryloxycarbonyl radicals, carbamoyl radicals, alkyl- or dialkyl-carbamoyl radicals, acyloxy radicals, acylamino radicals, aroylamino radicals, straight, branched or cyclic, alkylene radicals, or combination thereof. In an embodiment, substituent groups R have up to 50 non-hydrogen atoms, such as from 1 to 30 carbon, that can also be substituted with halogens or heteroatoms or the like, provided that when Cp′ is tetrahydro-s-indecenyl:
1) the 3 and/or 4 position is not aryl or substituted aryl,
2) the 3-position is not substituted with a group 15 or 16 heteroatom,
3) there are no additional rings fused to the tetrahydroindacenyl ligand,
4) T is not bonded to the 2-position, and
5) the 5, 6, or 7-position (such as the 6 position) is geminally disubstituted, such as with two C₁-C₁₀ alkyl groups.

Non-limiting examples of alkyl substituents R include methyl, ethyl, propyl, butyl, pentyl, hexyl, cyclopentyl, cyclohexyl, benzyl or phenyl groups and the like, including all their isomers, for example, tertiary butyl, isopropyl and the like. Other hydrocarbyl radicals include fluoromethyl, fluoroethyl, difluoroethyl, iodopropyl, bromohexyl chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methylbis(difluoromethyl)silyl, bromomethyldimethylgermyl and the like; and disubstituted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R include the atoms carbon, silicon, boron, aluminum, nitrogen, phosphorus, oxygen, tin, sulfur, germanium and the like, including olefins such as, but not limited to, olefinically unsaturated substituents including vinyl-terminated ligands, for example but-3-enyl, prop-2-enyl, hex-5-enyl and the like.

In at least one embodiment of Formula (VII) described herein, the Cp′ group, the substituent(s) R are, independently, hydrocarbyl groups, heteroatoms, or heteroatom containing groups, such as methyl, ethyl, propyl, butyl, pentyl, hexyl, heptyl, octyl, nonyl, decyl, undecyl, dodecyl or an isomer thereof, N, O, S, P, or a C₁ to C₂₀ hydrocarbyl substituted with an N, O, S and or P heteroatom or heteroatom containing group (typically having up to 12 atoms, including the N, O, S and P heteroatoms), provided that when Cp′ is tetrahydro-s-indecenyl, the 3 and/or 4 position are not aryl or substituted aryl, the 3 position is not substituted with a group 15 or 16 heteroatom, and there are no additional rings fused to the tetrahydroindacenyl ligand, T is not bonded to the 2-position, and the 5, 6, or 7-position (such as the 6 position) is geminally disubstituted, such as with two C₁-C₁₀ alkyl groups.

In at least one embodiment of Formula (VII), the Cp′ group is tetrahydro-as-indecenyl which may be substituted.

In at least one embodiment of Formula (VII), y is 1 and T is a bridging group containing at least one Group 13, 14, 15, or 16 element, in particular boron or a Group 14, 15 or 16 element. Examples of suitable bridging groups include P(═S)R*, P(═Se)R*, P(═O)R*, R*₂C, R*₂Si, R*₂Ge, R*₂CCR*₂, R*₂CCR*₂CR*₂, R*₂CCR*₂CR*₂CR*₂, R*C═CR*, R*C═CR*CR*₂, R*₂CCR*═CR*CR*₂, R*C═CR*CR*═CR*, R*C═CR*CR*₂CR*₂, R*₂CSiR*₂, R*₂SiSiR*₂, R*₂SiOSiR*₂, R*₂CSiR*₂CR*₂, R*₂SiCR*₂SiR*₂, R*C═CR*SiR*₂, R*₂CGeR*₂, R*₂GeGeR*₂, R*₂CGeR*₂CR*₂, R*₂GeCR*₂GeR*₂, R*₂SiGeR*₂, R*C═CR*GeR*₂, R*B, R*₂C—BR*, R*₂C—BR*—CR*₂, R*₂C—O—CR*₂, R*₂CR*₂C—O—CR*₂CR*₂, R*₂C—O—CR*₂CR*₂, R*₂C—O—CR*═CR*, R*₂C—S—CR*₂, R*₂CR*₂C—S—CR*₂CR*₂, R*₂C—S—CR*₂CR*₂, R*₂C—S—CR*═CR*, R*₂C—Se—CR*₂, R*₂CR*₂C—Se—CR*₂CR*₂, R*₂C—Se—CR*₂CR*₂, R*₂C—Se—CR*═CR*, R*₂C—N═CR*, R*₂C—NR*—CR*₂, R*₂C—NR*—CR*₂CR*₂, R*₂C—NR*—CR*═CR*, R*₂CR*₂C—NR*—CR*₂CR*₂, R*₂C—P═CR*, R*₂C—PR*—CR*₂, O, S, Se, Te, NR*, PR*, AsR*, SbR*, O—O, S—S, R*N—NR*, R*P—PR*, O—S, O—NR*, O—PR*, S—NR*, S—PR*, and R*N—PR* where R* is hydrogen or a C₁-C₂₀ containing hydrocarbyl, substituted hydrocarbyl, halocarbyl, substituted halocarbyl, silylcarbyl or germylcarbyl substituent and optionally two or more adjacent R* may join to form a substituted or unsubstituted, saturated, partially unsaturated or aromatic, cyclic or polycyclic substituent. Examples for the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In at least one embodiment, when Cp′ is tetrahydro-s-indecenyl and T is R*₂Si, then R* is not aryl.

In some embodiments, R* is not aryl or substituted aryl.

In some embodiments, T is represented by the formula ER^{d}₂ or (ER^{d}₂)₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{d} can form a cyclic structure including aromatic, partially saturated, or saturated cyclic or fused ring system. Preferably, T is a bridging group comprising carbon or silica, such as dialkylsilyl, such as T is selected from CH₂, CH₂CH₂, C(CH₃)₂, SiMe₂, cyclotrimethylenesilylene (Si(CH₂)₃), cyclopentamethylenesilylene (Si(CH₂)₅) and cyclotetramethylenesilylene (Si(CH₂)₄).

In some embodiments, R^{d} is not aryl or substituted aryl.

Illustrative, but not limiting, examples of metallocenes for use in a catalyst system include:
dimethylsilylene(2,6,6-trimethyl-1,5,6,7-tetrahydro-s-indacen-1-yl)(cyclododecylamido)M(R)₂ (such as TiCl₂ or TiMe₂),
dimethylsilylene(2,6,6-trimethyl-1,5,6,7-tetrahydro-s-indacen-1-yl)(t-butylamido)M(R)₂ (such as TiCl₂ or TiMe₂),
dimethylsilylene(6,6-dimethyl-1,5,6,7-tetrahydro-s-indacen-1-yl)(cyclododecylamido)M(R)₂ (such as TiCl₂ or TiMe₂),
dimethylsilylene (6,6-dimethyl-1,5,6,7-tetrahydro-s-indacen-1-yl)(t-butylamido)M(R)₂ (such as TiCl₂ or TiMe₂),
dimethylsilylene(2,7,7-trimethyl-3,6,7,8-tetrahydro-as-indacen-3-yl)(cyclododecylamido)M(R)₂ (such as TiCl₂ or TiMe₂),
dimethylsilylene(2,7,7-trimethyl-3,6,7,8-tetrahydro-as-indacen-3-yl)(t-butylamido)M(R)₂ (such as TiCl₂ or TiMe₂),
dimethylsilylene(7,7-dimethyl-3,6,7,8-tetrahydro-as-indacen-3-yl)(cyclododecylamido)M(R)₂ (such as TiCl₂ or TiMe₂),
dimethylsilylene(7,7-dimethyl-3,6,7,8-tetrahydro-as-indacen-3-yl)(t-butylamido)M(R)₂ (such as TiCl₂ or TiMe₂),
μ-(CH₃)₂Si(2,6,6-trimethyl-1,5,6,7-tetrahydro-s-indacen-1-yl)(1-adamantylamido)M(R)₂;
μ-(CH₃)₂Si(6,6-dimethyl-1,5,6,7-tetrahydro-s-indacen-1-yl)(1-adamantylamido)M(R)₂;
μ-(CH₃)₂Si(2-methyl-6,6-diethyl-1,5,6,7-tetrahydro-s-indacen-1-yl)(1-adamantylamido)M(R)₂;
μ-(CH₃)₂Si(6,6-diethyl-1,5,6,7-tetrahydro-s-indacen-1-yl)(1-adamantylamido)M(R)₂;
μ-(CH₃)₂Si(2,7,7-trimethyl-3,6,7,8-tetrahydro-as-indacen-3-yl)(1-adamantylamido)M(R)₂;
μ-(CH₃)₂Si(7,7-dimethyl-3,6,7,8-tetrahydro-as-indacen-3-yl)(1-adamantylamido)M(R)₂;
μ-(CH₃)₂Si(2-methyl-3,6,7,8-tetrahydro-as-indacen-3-yl)(1-adamantylamido)M(R)₂;
μ-(CH₃)₂Si(2-methyl-7,7-diethyl-3,6,7,8-tetrahydro-as-indacen-3-yl)(1-adamantylamido)M(R)₂;
μ-(CH₃)₂Si(7,7-diethyl-3,6,7,8-tetrahydro-as-indacen-3-yl)(1-adamantylamido)M(R)₂;
μ-(CH₃)₂Si(2,6,6-trimethyl-1,5,6,7-tetrahydro-s-indacen-1-yl)(t-butylamido)M(R)₂;
μ-(CH₃)₂Si(6,6-dimethyl-1,5,6,7-tetrahydro-s-indacen-1-yl)(t-butylamido)M(R)₂;
μ-(CH₃)₂Si(2-methyl-6,6-diethyl-1,5,6,7-tetrahydro-s-indacen-1-yl)(t-butylamido)M(R)₂;
μ-(CH₃)₂Si(6,6-diethyl-1,5,6,7-tetrahydro-s-indacen-1-yl)(t-butylamido)M(R)₂;
μ-(CH₃)₂Si(2,7,7-trimethyl-3,6,7,8-tetrahydro-as-indacen-3-yl)(t-butylamido)M(R)₂;
μ-(CH₃)₂Si(7,7-dimethyl-3,6,7,8-tetrahydro-as-indacen-3-yl)(t-butylamido)M(R)₂;
μ-(CH₃)₂Si(2-methyl-3,6,7,8-tetrahydro-as-indacen-3-yl)(t-butylamido)M(R)₂;
μ-(CH₃)₂Si(2-methyl-7,7-diethyl-3,6,7,8-tetrahydro-as-indacen-3-yl)(t-butylamido)M(R)₂;
μ-(CH₃)₂Si(7,7-diethyl-3,6,7,8-tetrahydro-as-indacen-3-yl)(t-butylamido)M(R)₂;
μ-(CH₃)₂Si(2,6,6-trimethyl-1,5,6,7-tetrahydro-s-indacen-1-yl)(cyclododecylamido)M(R)₂;
μ-(CH₃)₂Si(6,6-dimethyl-1,5,6,7-tetrahydro-s-indacen-1-yl)(cyclododecylamido)M(R)₂;
μ-(CH₃)₂Si(2-methyl-6,6-diethyl-1,5,6,7-tetrahydro-s-indacen-1-yl)(cyclododecylamido)M(R)₂;
μ-(CH₃)₂Si(6,6-diethyl-1,5,6,7-tetrahydro-s-indacen-1-yl)(cyclododecylamido)M(R)₂;
μ-(CH₃)₂Si(2,7,7-trimethyl-3,6,7,8-tetrahydro-as-indacen-3-yl)(cyclododecylamido)M(R)₂;
μ-(CH₃)₂Si(7,7-dimethyl-3,6,7,8-tetrahydro-as-indacen-3-yl)(cyclododecylamido)M(R)₂;
μ-(CH₃)₂Si(2-methyl-3,6,7,8-tetrahydro-as-indacen-3-yl)(cyclododecylamido)M(R)₂;
μ-(CH₃)₂Si(2-methyl-7,7-diethyl-3,6,7,8-tetrahydro-as-indacen-3-yl)(cyclododecylamido)M(R)₂;
μ-(CH₃)₂Si(7,7-diethyl-3,6,7,8-tetrahydro-as-indacen-3-yl)(cyclododecylamido)M(R)₂;
μ-(CH₂)₃Si(2,6,6-trimethyl-1,5,6,7-tetrahydro-s-indacen-1-yl)(t-butylamido)M(R)₂;
μ-(CH₂)₄Si(2,6,6-trimethyl-1,5,6,7-tetrahydro-s-indacen-1-yl)(t-butylamido)M(R)₂;
μ-(CH₂)₅Si(2,6,6-trimethyl-1,5,6,7-tetrahydro-s-indacen-1-yl)(t-butylamido)M(R)₂;
μ-(CH₃)₂C(2,6,6-trimethyl-1,5,6,7-tetrahydro-s-indacen-1-yl)(t-butylamido)M(R)₂;
μ-(CH₂)₃Si(2,6,6-trimethyl-1,5,6,7-tetrahydro-s-indacen-1-yl)(t-butylamido)M(R)₂;
μ-(CH₂)₄Si(2,6,6-trimethyl-1,5,6,7-tetrahydro-s-indacen-1-yl)(t-butylamido)M(R)₂;
μ-(CH₂)₅Si(2,6,6-trimethyl-1,5,6,7-tetrahydro-s-indacen-1-yl)(t-butylamido)M(R)₂;
μ-(CH₃)₂C(2,6,6-trimethyl-1,5,6,7-tetrahydro-s-indacen-1-yl)(t-butylamido)M(R)₂; and
μ-(CH₃)₂Si(2,6,6-trimethyl-1,5,6,7-tetrahydro-s-indacen-1-yl)(neopentylamido)M(R)₂;
   where M is selected from a group consisting of Ti, Zr, and Hf and R is selected from halogen or C₁ to C₅ alkyl, such as R is a methyl group or a halogen group, (such as TiCl₂ or TiMe₂), such as provided however that, when the compound is dimethylsilylene(2,6,6-trimethyl-1,5,6,7-tetrahydro-s-indacen-1-yl)(Z)Ti(R)₂ or μ-(CH₃)₂Si(2-methyl-3,6,7,8-tetrahydro-as-indacen-3-yl)(Z)Ti(R)₂, where Z is t-butylamido, adamantylamido, cyclooctylamido, cyclohexylamido or cyclododecylamido, then R is not methyl.

In at least one embodiment, a catalyst system includes μ-(CH₃)₂Si(η⁵-2,6,6-trimethyl-1,5,6,7-tetrahydro-s-indacen-1-yl)(tertbutylamido)M(R)₂; where M is selected from a group consisting of Ti, Zr, and Hf and R is selected from halogen or C₁ to C₅ alkyl, such as, R is a methyl group. In an embodiment, M is Ti and R is Cl, Br or Me.

In alternate embodiments, two or more different transition metal compounds may be used herein. For purposes of the present disclosure one transition metal compound is considered different from another if they differ by at least one atom. For example “Me₂Si(2,7,7-Me₃-3,6,7,8-tetrahydro-as-indacen-3-yl)(cyclohexylamido)TiCl₂” is different from “Me₂Si(2,7,7-Me₃-3,6,7,8-tetrahydro-as-indacen-3-yl)(n-butylamido)TiCl₂” which is different from Me₂Si(2,7,7-Me₃-3,6,7,8-tetrahydro-as-indacen-3-yl)(n-butylamido)HfCl₂.

In at least one embodiment, one mono-tetrahydroindacenyl compound as described herein is used in the catalyst system.

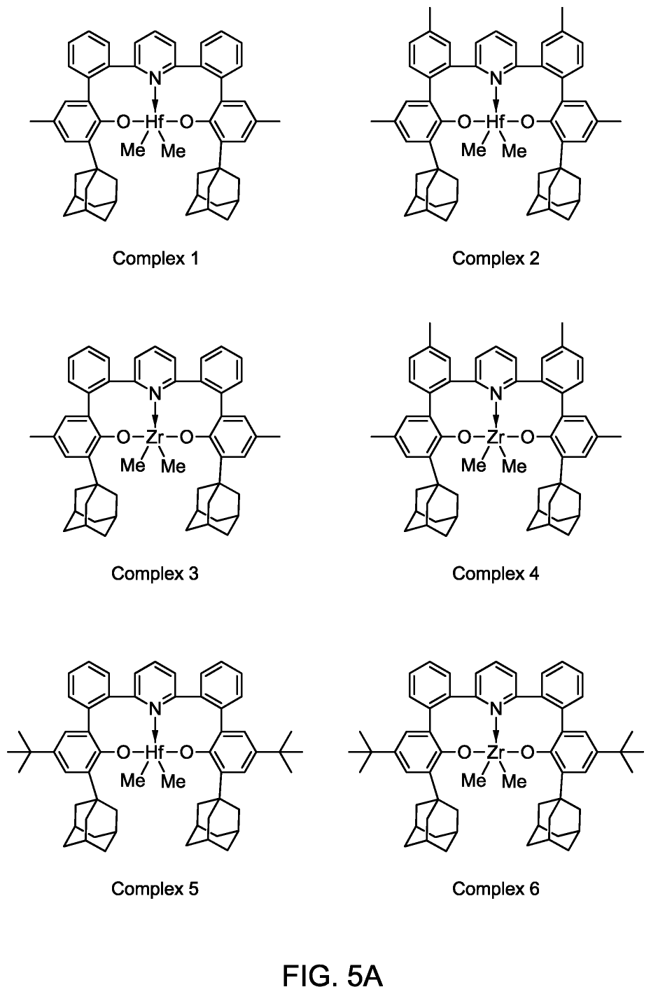

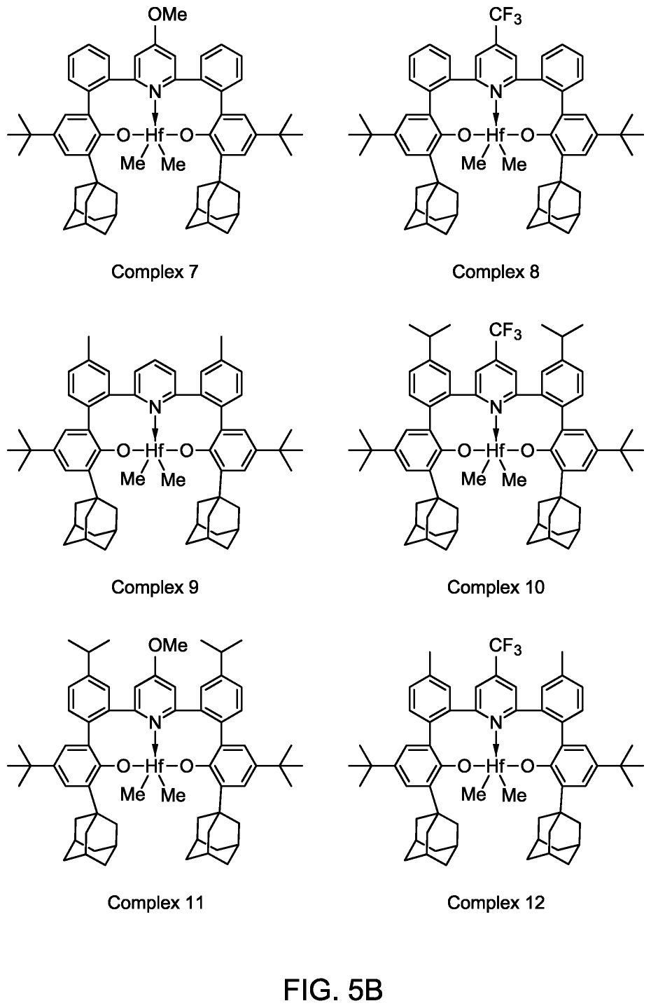

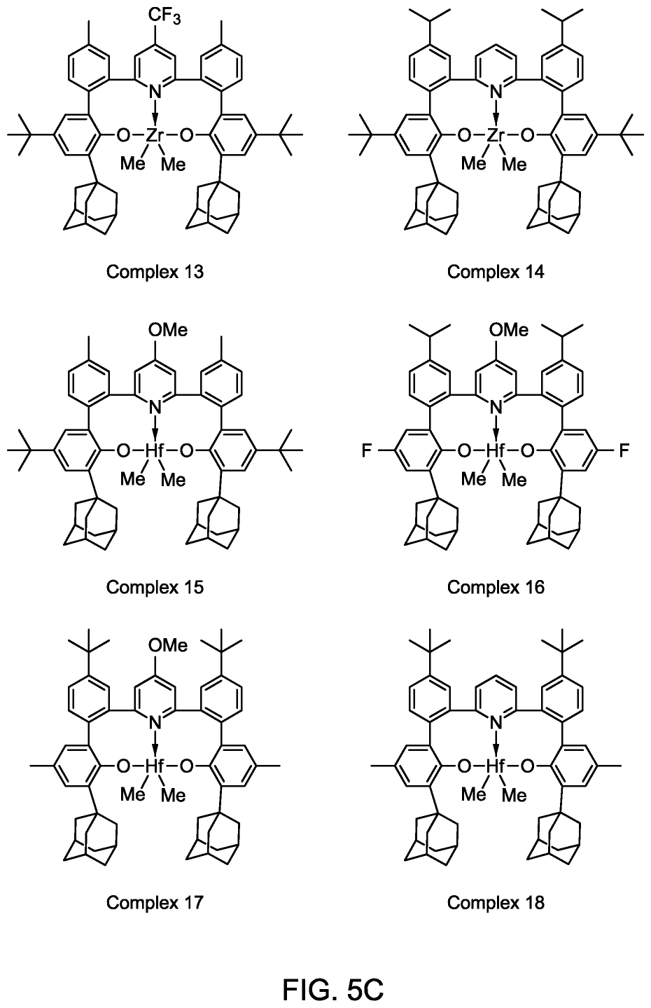

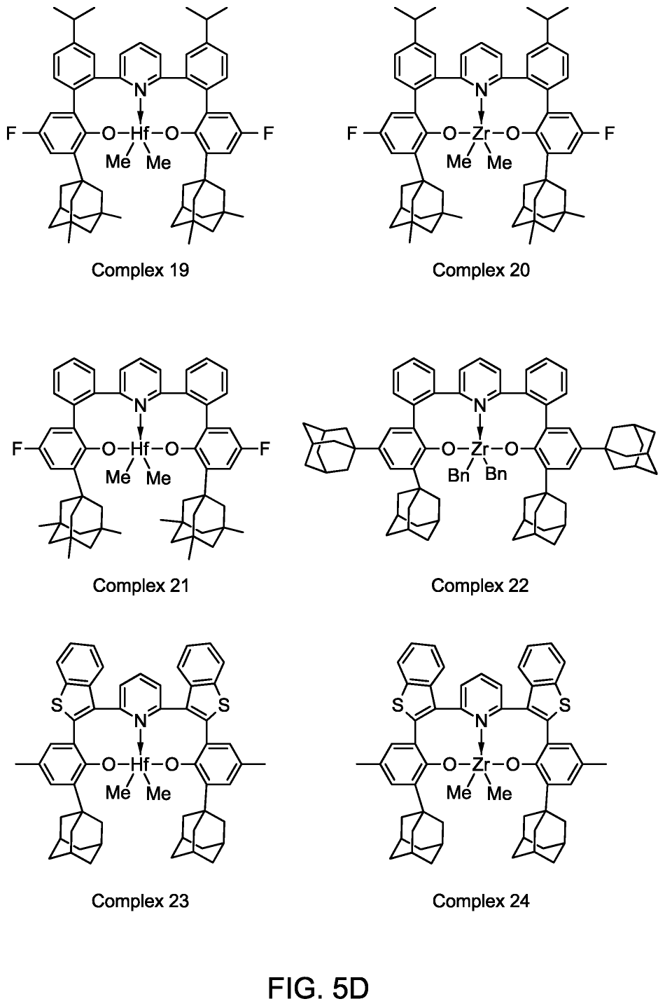

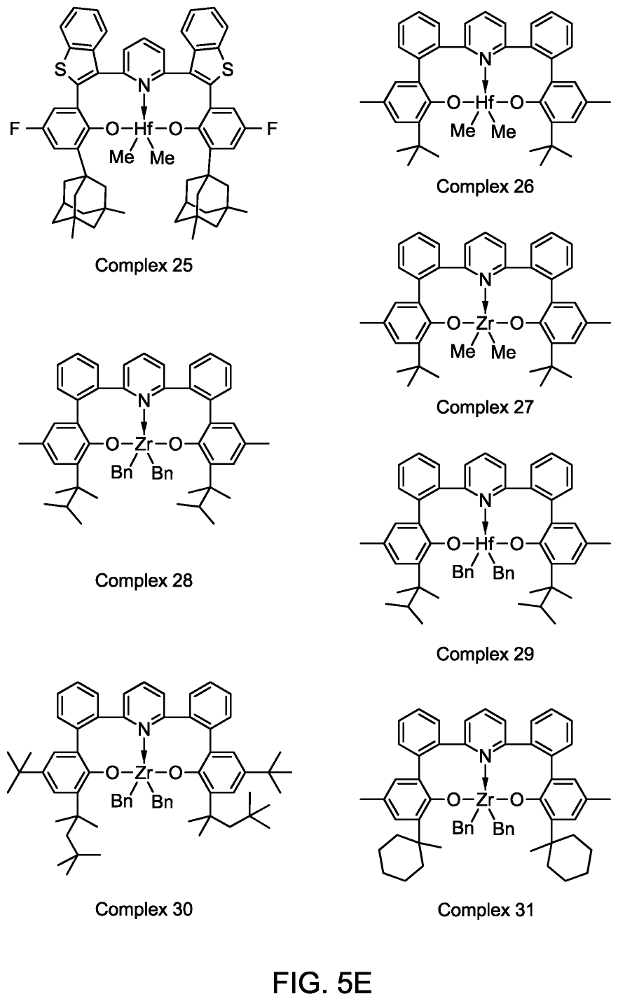

Catalyst compounds that are particularly useful in this invention include those represented by one or more of the complexes of FIGS. 5A, 5B, 5C, 5D, and 5E.

### Activators

The terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Activators typically include alumoxane compounds, modified alumoxane compounds, and ionizing anion precursor compounds that abstract a reactive, σ-bound, metal ligand making the metal complex cationic and providing a charge-balancing non-coordinating or weakly coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), some embodiments select the maximum amount of activator typically at up to a 5,000-fold molar excess Al/M over the catalyst compound (per metal catalytic site). The minimum activator-to-catalyst-compound is a 1:1 molar ratio. Alternate ranges include from 1:1 to 500:1, alternately from 1:1 to 200:1, alternately from 1:1 to 100:1, or alternately from 1:1 to 50:1.

### Non Coordinating Anion Activators

Non-coordinating anion activators may also be used herein. The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

It is within the scope of the present disclosure to use an ionizing or stoichiometric activator, neutral or ionic, such as tri (n-butyl) ammonium tetrakis (pentafluorophenyl) borate, a tris perfluorophenyl boron metalloid precursor or a tris perfluoronaphthyl boron metalloid precursor, polyhalogenated heteroborane anions (WO 1998/043983), boric acid (U.S. Pat. No. 5,942,459), in combination with the alumoxane or modified alumoxane activators. It is also within the scope of the present disclosure to use neutral or ionic activators in combination with the alumoxane or modified alumoxane activators.

The catalyst systems of the present disclosure can include at least one non-coordinating anion (NCA) activator. Specifically, the catalyst systems may include an NCAs which either do not coordinate to a cation or which only weakly coordinate to a cation thereby remaining sufficiently labile to be displaced during polymerization.

The terms “cocatalyst” and “activator” are used herein interchangeably and are defined to be any compound which can activate any one of the catalyst compounds described above by converting the neutral catalyst compound to a catalytically active catalyst compound cation.

In at least one embodiment, boron containing NCA activators represented by the formula below can be used:

Z_{d}⁺(A^{d-})

where: Z is (L—H) or a reducible Lewis acid; L is a neutral Lewis base; H is hydrogen; (L—H) is a Bronsted acid; A^{d-} is a boron containing non-coordinating anion having the charge d−; d is 1, 2, or 3.

The cation component, Z_{d}⁺ may include Bronsted acids such as protons or protonated Lewis bases or reducible Lewis acids capable of protonating or abstracting a moiety, such as an alkyl or aryl, from the bulky ligand metallocene containing transition metal catalyst precursor, resulting in a cationic transition metal species.

The activating cation Z_{d}⁺ may also be a moiety such as silver, tropylium, carboniums, ferroceniums and mixtures, such as carboniums and ferroceniums. Such as Z_{d}⁺ is triphenyl carbonium. Reducible Lewis acids can be any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), such as the reducible Lewis acids in Formula (14) above as “Z” include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbonium.

When Z_{d}⁺ is the activating cation (L—H)d⁺, it is preferably a Bronsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}Qₙ]^{d-} wherein k is 1, 2, or 3; n is 1, 2, 3, 4, 5, or 6 (such as 1, 2, 3, or 4); n−k=d; M is an element selected from Group 13 of the Periodic Table of the Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst are the compounds described as (and particularly those specifically listed as) activators in U.S. Pat. No. 8,658,556, which is incorporated by reference herein.

For example, the ionic stoichiometric activator Z_{d}⁺ (A^{d-}) is one or more of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Bulky activators are also useful herein as NCAs. “Bulky activator” as used herein refers to anionic activators represented by the formula:

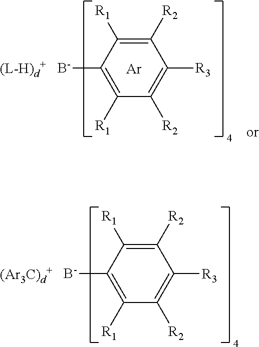

where: each R₁ is, independently, a halide, such as a fluoride; Ar is substituted or unsubstituted aryl group (such as a substituted or unsubstituted phenyl), such as substituted with C₁ to C₄₀ hydrocarbyls, such as C₁ to C₂₀ alkyls or aromatics; each R₂ is, independently, a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₂ is a fluoride or a perfluorinated phenyl group); each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₃ is a fluoride or a C₆ perfluorinated aromatic hydrocarbyl group); wherein R₂ and R₃ can form one or more saturated or unsaturated, substituted or unsubstituted rings (such as R₂ and R₃ form a perfluorinated phenyl ring); and L is an neutral Lewis base; (L'H)⁺ is a Bronsted acid; d is 1, 2, or 3; wherein the anion has a molecular weight of greater than 1,020 g/mol; wherein at least three of the substituents on the B atom each have a molecular volume of greater than 250 cubic Å, alternately greater than 300 cubic Å, or alternately greater than 500 cubic Å.

For example, (Ar₃C)_{d}⁺ is (Ph₃C)_{d}⁺, where Ph is a substituted or unsubstituted phenyl, such as substituted with C₁ to C₄₀ hydrocarbyls or substituted C₁ to C₄₀ hydrocarbyls, such as C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple ‘Back of the Envelope’ Method for Estimating the Densities and Molecular Volumes of Liquids and Solids,” Journal of Chemical Education, v.71(11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using the following table of relative volumes. For fused rings, the V_{S} is decreased by 7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful Bulky activators please see U.S. Pat. No. 8,658,556, which is incorporated by reference herein.

In another embodiment, one or more of the NCA activators is chosen from the activators described in U.S. Pat. No. 6,211,105.

Activators can include N,N-dimethylanilinium tetrakis(pentafluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In at least one embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkyl ammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical NCA activator-to-catalyst ratio, e.g., all NCA activators-to-catalyst ratio is about a 1:1 molar ratio. Alternate ranges include from 0.1:1 to 100:1, alternately from 0.5:1 to 200:1, alternately from 1:1 to 500:1 alternately from 1:1 to 1000:1. A particularly useful range is from 0.5:1 to 10:1, such as 1:1 to 5:1.

Activators useful herein also include those described in U.S. Pat. No. 7,247,687 at column 169, line 50 to column 174, line 43, particularly column 172, line 24 to column 173, line 53.

It is also within the scope of the present disclosure that the catalyst compounds can be combined with combinations of alumoxanes and NCA's (see for example, U.S. Pat. Nos. 5,153,157, 5,453,410, EP 0 573 120 B1, WO 1994/007928, and WO 1995/014044 which discuss the use of an alumoxane in combination with an ionizing activator).

### Experimental Section

The foregoing discussion can be further described with reference to the following non-limiting examples, of which, the testing procedures are described below.

### Test Methods

Due to strong ion cluster formation, the ionomers are typically not soluble in any solvent. The moments of molecular weight of the metal alkenyl containing copolymer are determined by acidification of the ionomers to make them soluble in trichlorobenzene TCB. Thereafter, Gel Permeation Chromatography (GPC) is performed on the acidified copolymers to measure the moments of molecular weight. For purposes of this invention and the claims thereto, the moments of molecular weight of the acidified polymers shall be considered the moments of molecular weight of the polymer prior to be acidified.

4D Gel Permeation Chromotography: Unless otherwise indicated, the distribution and the moments of molecular weight (Mw, Mn, Mz, Mw/Mn, etc.), the comonomer content, and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm−1 to about 3,000 cm−1 (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, α and K for other materials are as calculated by GPC ONE™ 2019f software (Polymer Characterization, S.A., Valencia, Spain). Concentrations are expressed in g/cm3, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH₃end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A2 is the second virial coefficient, P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, (dn/dc) is the refractive index increment for the system, n=1.500 for TCB at 145° C., and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the equation [η]=η/c, where c is concentration and is determined from the IR5 broadband channel output. The viscosity MW at each point is calculated as M=K_{PS}M^{α}^{_{PS}}⁺¹/[η], where αps is 0.67 and Kps is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{α}} ,$$

where Mv is the viscosity-average molecular weight based on molecular weights determined by LS analysis and the K and α are for the reference linear polymers are calculated by GPC ONE™ 2019f software (Polymer Characterization, S.A., Valencia, Spain). Concentrations are expressed in g/cm3, molecular weight is expressed in g/mole, and intrinsic viscosity (hence K in the Mark-Houwink equation) is expressed in dL/g unless otherwise noted. Calculation of the w2b values is as discussed above.

### Differential Scanning Calorimetry (DSC)

Crystallization temperature (Tc) and melting temperature (or melting point, Tm) are measured using Differential Scanning calorimetry (DSC) on a commercially available instrument (e.g., TA Instruments 2920 DSC or TA Instruments 2900 DSC). Typically, 6 mg to 10 mg of molded polymer or plasticized polymer are sealed in an aluminum pan and loaded into the instrument at room temperature. Melting data (first heat) is acquired by heating the sample to at least 30° C. above its melting temperature, typically 200° C. for polypropylene, at a heating rate of 10° C./min. The sample is held for at least 5 minutes at this temperature to destroy its thermal history. Crystallization data are acquired by cooling the sample from the melt to at least 50° C. below the crystallization temperature at a cooling rate of 10° C./min. The sample is held at this temperature for at least 5 minutes, and finally heated at 10° C./min. to acquire additional melting data (second heat). The endothermic melting transition (first and second heat) and exothermic crystallization transition are analyzed according to standard procedures. The melting temperatures reported are the peak melting temperatures from the second heat unless otherwise specified. For Tg determination herein, temperature ramps from −150° C. to 150° C. with a 10° C./min. heating rate were carried out using a DSC2500TM (TA Instruments™).

For polymers displaying multiple peaks, the melting temperature is defined to be the peak melting temperature from the melting trace associated with the largest endothermic calorimetric response (as opposed to the peak occurring at the highest temperature). Likewise, the crystallization temperature is defined to be the peak crystallization temperature from the crystallization trace associated with the largest exothermic calorimetric response (as opposed to the peak occurring at the highest temperature).

Areas under the DSC curve are used to determine the heat of transition (heat of fusion, Hf, upon melting), which can be used to calculate the degree of crystallinity (also called the percent crystallinity). The percent crystallinity (X %) is calculated using the formula: [area under the curve (in J/g)/H° (in J/g)]*100, where H° is the ideal heat of fusion for a perfect crystal of the homopolymer of the major monomer component. These values for H° are to be obtained from the Polymer Handbook, Fourth Edition, published by John Wiley and Sons, New York 1999, except that a value of 290 J/g is used for H° (polyethylene), a value of 140 J/g is used for H° (polybutene), and a value of 207 J/g is used for H° (polypropylene).

### ¹H NMR

Proton NMR spectra are collected using a suitable instrument, e.g., a 500 MHz Varian pulsed Fourier transform NMR spectrometer equipped with a variable temperature proton detection probe operating at 120° C. Typical measurement of the NMR spectrum include dissolving of the polymer sample in 1,1,2,2-tetrachloroethane-d2 (“TCE-d2”) and transferring into a 5 mm glass NMR tube. Typical acquisition parameters are sweep width of 10 KHz, pulse width of 30 degrees, acquisition time of 2 seconds, acquisition delay of 5 seconds and number of scans was 120. Chemical shifts are determined relative to the TCE-d2 signal which was set to 5.98 ppm.

### Dynamic Mechanical Thermal Analysis

Dynamic mechanical thermal analysis (“DMTA”) was performed using a solid analyzer instrument RSA-G2 (TA Instruments). The samples were prepared as small rectangular samples, the whole sample approximately 19.0 mm long by 5 mm wide by 0.5 mm thick. The polymer samples were molded at approximately 150° C. on either a Carver Lab Press or Wabash Press. The polymer samples are then loaded into the open oven of the instrument between tool clamps on both ends. Small strips of dimensions 50 mm×2 mm×0.5 mm are cut from the plaques and loaded in the RSA-G2 using the fibers tool. The temperature is controlled with a forced convection oven. Dynamic temperature ramps are conducted at a heating rate of 2° C./min using a frequency of 1 Hz and strain of 0.1%. The elastic and viscous moduli (E′ and E″) are measured as a function of temperature.

### Fourier-Transform Infrared Spectroscopy

Fourier-Transform infrared (FTIR) spectroscopy was used to roughly estimate the amount of potassium acetate groups in the AVTA-K polymers. A potassium acetate (KOAc) standard was prepared for FTIR analysis by weighing out 1.4 mg of KOAc in a small vial and adding 576.6 mg of potassium bromide (KBr). The KOAc and KBr powders were mixed by rotating the vial around for several minutes to thoroughly mix the components before emptying the entire contents of the vial into a 1.3 cm diameter KBr die. A vacuum pump was attached to the KBr die using a rubber hose to remove air before it was pressed with a load of 10 tons for ˜10 minutes. Dimensions of the KOAc containing KBr pellet were evaluated with a micrometer, where the disc measured 1.3 cm in diameter and 1.602 mm in thickness equating to a volume of 0.2126 cm3. A concentration of 0.0664 M KOAc in the KBr pellet was estimated using the 1.4 mg mass (>99% purity and molecular weight of 98.15 g/mol) and 0.2126 cm3 KBr disc volume. From the KOAc concentration in the KBr disc, a molar absorptivity for KOAc was estimated by acquiring an FTIR spectrum of the disc and measuring the peak absorbance of the C—O stretch at 1,572 cm−1. The peak absorbance of the C—O stretch at 1,572 cm−1 and the molarity of KOAc in the KBr disc were used to calculate a KOAc molar absorptivity of ε=132.5 M−1cm−1. AVTA-K polymers containing KOAc functional groups were pressed into polymer plaques ranging in thickness from 85 to ˜350 μm at 204° C. (400° F.). FTIR spectra were acquired from the AVTA-K polymer plaques, where the peak absorbance of the C—O stretch in the polymer and the KOAc molar absorptivity were used to estimate the concentration of KOAc groups using Beer's Law.

$$Polymer AVTA - KOAc ( m ) = \frac{Peak Absorbance C - O stretch}{( ε = 132.5 {M}^{- 1} {cm}^{- 1} ) ( polymer thickness ( cm ) )}$$

A mole ratio of AVTA-KOAc groups to ethylene or propylene monomer was calculated for the AVTA-K polymers by using the KOAc molar concentration determined from the peak absorbance of the C—O stretch and assuming the AVTA-K polymers had an amorphous density of ˜0.853 g/cm3. Density of the AVTA-K polymers were assumed to be an average of the amorphous density for polypropylene (0.850 g/cm3) and polyethylene (0.856 g/cm3) polymers. The AVTA-KOAc group has a molecular weight of 194.32 g/mol and the monomer molecular weight of the polymer was ascertained from the average composition determined by NMR from the control polymers that lacked AVTA-KOAc functionality. In cases where the NMR composition was not available, the molecular weight for the monomer was chosen to be the primary monomer used to synthesize the AVTA-K polymer. Equations for determining the mole ratio of AVTA-KOAc groups to monomer for the AVTA-K polymers is given below.

$$monomer molecular weight \frac{g}{mol} = \frac{( Fraction of PE ) ( 28.015 \frac{g}{mol} ) + ( Fraction of PP ) ( 42.08 \frac{g}{mol} )}{2}$$

$$\frac{moles AVTA - KOAc}{moles of EPDM polymer} = \frac{( AVTA - KOAc ( M ) ) ( monomer molecular weight ( \frac{g}{mol} ) )}{( 853 ( \frac{g}{L} ) )}$$

A similar relationship can be used to calculate a mass ratio of AVTA-KOAc groups to polymer by using a molecular weight of 194.32 g/mol for the AVTA-KOAc group. The equation to determine the mass ratio is given with tabulated values below.

$$\frac{mass AVTA - KOAc}{mass of EPDM polymer} = \frac{\begin{matrix}( AVTA - KOAc ( M ) ) ( AVTA - \\ KOAc molecular weight 194.32 \frac{g}{mol} )\end{matrix}}{( 853 ( \frac{g}{L} ) )}$$

### Tensile Properties

Tensile Properties (ultimate tensile strength, elongation at break, tensile yield, elongation at yield,) were determined using a RSA-G2 instrument (TA Instruments) using dogbone specimens with 5 mm×5 mm×0.5 mm dimensions.

### Polymer Preparation

In the following examples, Catalyst-1 is (Me₂Si(η⁵-2,6,6-trimethyl-1,5,6,7-tetrahydro-s-indacen-1-yl)(η¹-N^{t}Bu)TiMe₂) and was prepared according to U.S. Pat. No. 9,796,795 (Catalyst A). Activator-1 is (N,N-dimethylanilinium tetrakis(pentafluorophenyl)borate) and was purchased from W. R. Grace and Conn. Activator 2 is (N,N-dimethylanilinium tetrakis(pentafluoronaphth-2-yl)borate) and was purchased from W. R. Grace and Conn. Ethylidene norbornene (ENB), decene, and octadecene were purchased from Sigma Aldrich, degassed by nitrogen bubbling, filtered through neutral aluminum, and stored over molecular sieves. KO^{t}Bu was purchased from Sigma Aldrich and used as received.

Preparation of Di(isobutyl)(7-octen-1-yl)aluminum (AV-1/8)

AV synthesis is described in copending US Publication No. 2018/0194872, which is assigned to the applicant of the present application, and is incorporated by reference herein. Under N₂ atmosphere, a 1,000 mL round bottom flask was charged with 663 mL of 1,7-octadiene (4,488.8 mmol) and a stir bar. The flask was brought to 60° C. To the flask was slowly added neat diisobutyl aluminum hydride (63.8 g, 448.9 mmol) dropwise (around 3 droplets per second). After the completion of addition, the reaction was stirred at 60° C. for an additional 30 minutes. The excess 1,7-octadiene was distilled off under a dynamic vacuum at 55° C., resulting in a colorless liquid of the desired product. Yield: 108 g. On the basis of ¹H NMR integration, the product AV-1/8 molecular formula was assigned as (C₄H₉)_{2.1}Al(C₈H₁₅)_{0.9}. ¹H NMR (400 MHz, benzene-d₆): δ=5.78 (m, 1H, ═CH), 5.01 (m, 2H, ═CH₂), 1.95 (m, 4H, —CH₂), 1.54 (m, 2H, ⁱBu—CH), 1.34 (m, 6H, —CH₂), 1.04 (d, 12H, ⁱBu—CH₃), 0.49 (t, 2H, Al—CH₂), 0.27 (d, 4H, ⁱBu—CH₂) ppm.

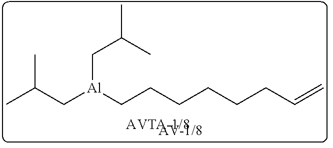

### Preparation of Linear α-Olefin-AV Copolymers

Ethylene (C₂H₄) and propylene (C₃H₆) or an LAO were copolymerized with AV-1/8 (di(isobutyl)(7-octen-1-yl)aluminum) by vinyl addition polymerization using catalyst 1 (the structure shown below). Some samples were prepared without AV-1/8, as controls.

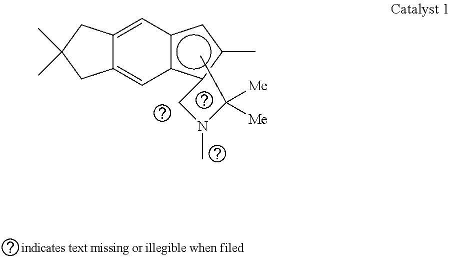

Control 1: A 2 L autoclave reactor was charged with 600 mL isohexane. To the reactor was added propylene (100 mL), and 25 wt % hexane solution of tri-n-octyl aluminum (TNOAL, 2 mL; purchased from Sigma Aldrich). The reactor was brought to 65° C., and ethylene was introduced to the reactor (80 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 100 psig ethylene pressure and a temperature of 70° C. The polymerization was stirred at 650 rpm, and was terminated by introduction of air 15 minutes after the catalyst injection. Polymers were washed with methanol (300 mL), isolated by filtration, and dried under vacuum at 70° C. for 12 hours. Yield: 43.47 g.

Example 1: A 2 L autoclave reactor was charged with 600 mL isohexane. To the reactor was added propylene (100 mL), AV-1/8 (10 mL), and bis(diisobutylaluminum) oxide (DIBALO, 1 mL of 20 wt % hexane solution; purchased from Nouryon). The reactor was brought to 65° C., and ethylene was introduced to the reactor (80 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 100 psig ethylene pressure and a temperature of 70° C. The polymerization was stirred at 650 rpm, and was terminated by introduction of 200 psig CO₂ 15 minutes after the catalyst injection. The reaction was allowed to stir for an additional 30 minutes. Reaction was cooled to 40° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, and dried under vacuum at 70° C. for 12 hours. Yield: 45.31 g.

Control 2: A 2L autoclave reactor was charged with 600 mL isohexane. To the reactor was added propylene (75 mL), and 25 wt % hexane solution of tri-n-octyl aluminum (TNOAL, 2 mL; purchased from Sigma Aldrich). The reactor was brought to 65° C., and ethylene was introduced to the reactor (100 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 120 psig ethylene pressure and a temperature of 70° C. The polymerization was stirred at 650 rpm, and was terminated by introduction of air 15 minutes after the catalyst injection. Polymers were washed with methanol (300 mL), isolated by filtration, stabilized by addition of around 1,000 ppm Irganox 1076, and dried under vacuum at 70° C. for 12 hours. Yield: 28 g.

Example 2: A 2L autoclave reactor was charged with 600 mL isohexane. To the reactor was added propylene (75 mL), AV-1/8 (3 mL), and bis(diisobutylaluminum) oxide (DIBALO, 1 mL of 20 wt % hexane solution; purchased from Nouryon). The reactor was brought to 65° C., and ethylene was introduced to the reactor (100 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 120 psig ethylene pressure and a temperature of 70° C. The polymerization was stirred at 650 rpm, and was terminated by introduction of 200 psig CO₂ 15 minutes after the catalyst injection. The reaction was allowed to stir for an additional 30 minutes. Reaction was cooled to 40° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, stabilized by addition of around 1,000 ppm Irganox 1076, and dried under vacuum at 70° C. for 12 hours. Yield: 35 g.

Control 3: A 2L autoclave reactor was charged with 600 mL isohexane. To the reactor was added propylene (75 mL), ENB (10 mL), and 25 wt % hexane solution of tri-n-octyl aluminum (TNOAL, 2 mL; purchased from Sigma Aldrich). The reactor was brought to 65° C., and ethylene was introduced to the reactor (100 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 120 psig ethylene pressure and a temperature of 70° C. The polymerization was stirred at 650 rpm, and was terminated by introduction of air 15 minutes after the catalyst injection. Polymers were washed with methanol (300 mL), isolated by filtration, stabilized by addition of around 1,000 ppm Irganox 1076, and dried under vacuum at 70° C. for 12 hours. Yield: 49.06 g.

Example 3: A 2L autoclave reactor was charged with 600 mL isohexane. To the reactor was added propylene (75 mL), ENB (10 mL), AV-1/8 (3 mL), and bis(diisobutylaluminum) oxide (DIBALO, 1 mL of 20 wt % hexane solution; purchased from Nouryon). The reactor was brought to 65° C., and ethylene was introduced to the reactor (100 psig). At 65° C., a 20 mL toluene solution of Catalyst 1 (5.0 mg) and Activator 1 N,N-Dimethylanilinium tetrakis(pentafluorophenyl)borate [PhNMe2H][B(C6F5)4] (10.9 mg) was injected, along with 200 mL of isohexane, to initiate the polymerization. Immediately after the catalyst injection, an additional 20 psig ethylene was added to maintain a steady-state 120 psig ethylene pressure and a temperature of 70° C. The polymerization was stirred at 650 rpm, and was terminated by introduction of 200 psig CO₂ 15 minutes after the catalyst injection. The reaction was allowed to stir for an additional 30 minutes. Reaction was cooled to 40° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, stabilized by addition of around 1,000 ppm Irganox 1076, and dried under vacuum at 70° C. for 12 hours. Yield: 48 g.

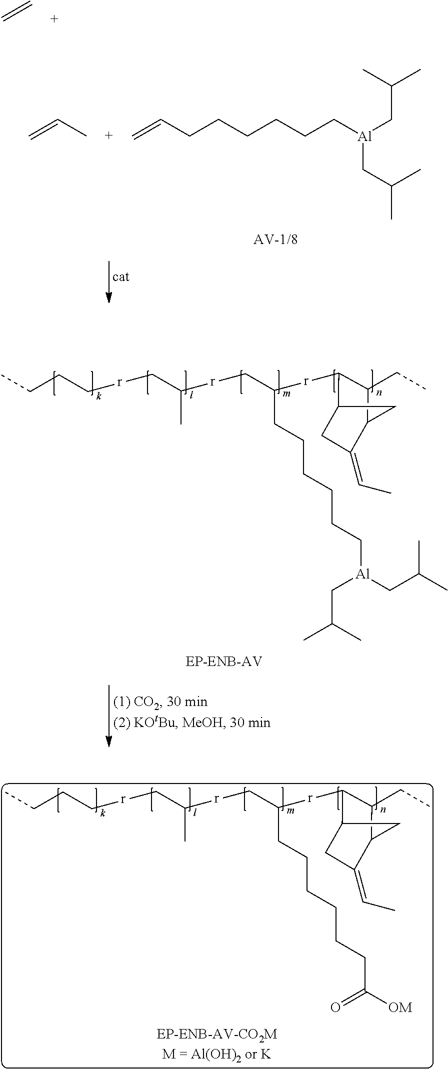

Example 4: A 2L autoclave reactor was charged with 300 mL isohexane. To the reactor was added decene (75 mL), ENB (10 mL), AV-1/8 (3 mL), and bis(diisobutylaluminum) oxide (DIBALO, 1 mL of 20 wt % hexane solution; purchased from Nouryon). The reactor was brought to 65° C., and ethylene was introduced to the reactor (80 psig). At 55° C., a 20 mL toluene solution of Catalyst 1 (5.0 mg) and Activator 2 [PhNMe2H][B(C10F7)4] (15.7 mg) was injected, along with 200 mL of isohexane, to initiate the polymerization. Immediately after the catalyst injection, an additional 20 psig ethylene was added to maintain a steady-state 100 psig ethylene pressure and a temperature of 60° C. The polymerization was stirred at 650 rpm, and was terminated by introduction of 100 psig CO₂ 15 minutes after the catalyst injection. The reaction was allowed to stir for an additional 30 minutes. Reaction was cooled to 40° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, stabilized by addition of around 1,000 ppm Irganox 1076, and dried under vacuum at 70° C. for 12 hours. Yield: 97 g.

Example 5: A 2L autoclave reactor was charged with 300 mL isohexane. To the reactor was added decene (75 mL), ENB (10 mL), AV-1/8 (3 mL), and bis(diisobutylaluminum) oxide (DIBALO, 1 mL of 20 wt % hexane solution; purchased from Nouryon). The reactor was brought to 35° C., and ethylene was introduced to the reactor (100 psig). At 35° C., a 20 mL toluene solution of Catalyst 1 (5.0 mg) and Activator 2 [PhNMe2H][B(C10F7)4] (15.7 mg) was injected, along with 200 mL of isohexane, to initiate the polymerization. Immediately after the catalyst injection, an additional 20 psig ethylene was added to maintain a steady-state 120 psig ethylene pressure and a temperature of 40° C. The polymerization was stirred at 650 rpm, and was terminated by introduction of 100 psig CO₂ 15 minutes after the catalyst injection. The reaction was allowed to stir for an additional 30 minutes. Reaction was cooled to 30° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, stabilized by addition of around 1,000 ppm Irganox 1076, and dried under vacuum at 70° C. for 12 hours. Yield: 90 g.

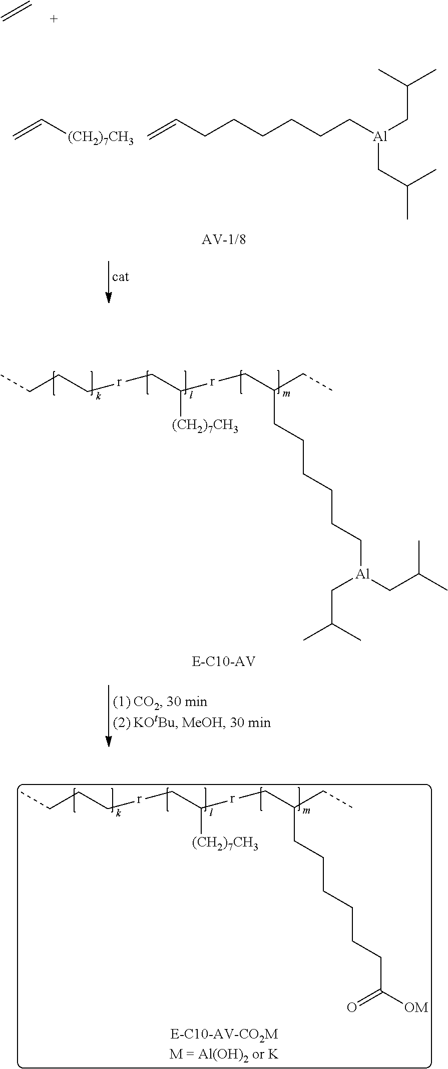

Example 6: A 2L autoclave reactor was charged with 300 mL isohexane. To the reactor was added decene (75 mL), ENB (10 mL), AV-1/8 (3 mL), and bis(diisobutylaluminum) oxide (DIBALO, 1 mL of 20 wt % hexane solution; purchased from Nouryon). The reactor was brought to 75° C., and ethylene was introduced to the reactor (60 psig). At 75° C., a 20 mL toluene solution of Catalyst 1 (5.0 mg) and Activator 2 [PhNMe2H][B(C10F7)4] (15.7 mg) was injected, along with 200 mL of isohexane, to initiate the polymerization. Immediately after the catalyst injection, an additional 20 psig ethylene was added to maintain a steady-state 80 psig ethylene pressure and a temperature of 80° C. The polymerization was stirred at 650 rpm, and was terminated by introduction of 100 psig CO₂ 15 minutes after the catalyst injection. The reaction was allowed to stir for an additional 30 minutes. Reaction was cooled to 40° C., and the pressure was released from vent valves. A methanol solution (300 mL) of KOtBu (20 g) was added to the reactor. The reaction heated at 70° C. for 30 minutes. Polymers were washed with methanol (300 mL), isolated by filtration, stabilized by addition of around 1,000 ppm Irganox 1076, and dried under vacuum at 70° C. for 12 hours. Yield: 81.15 g.

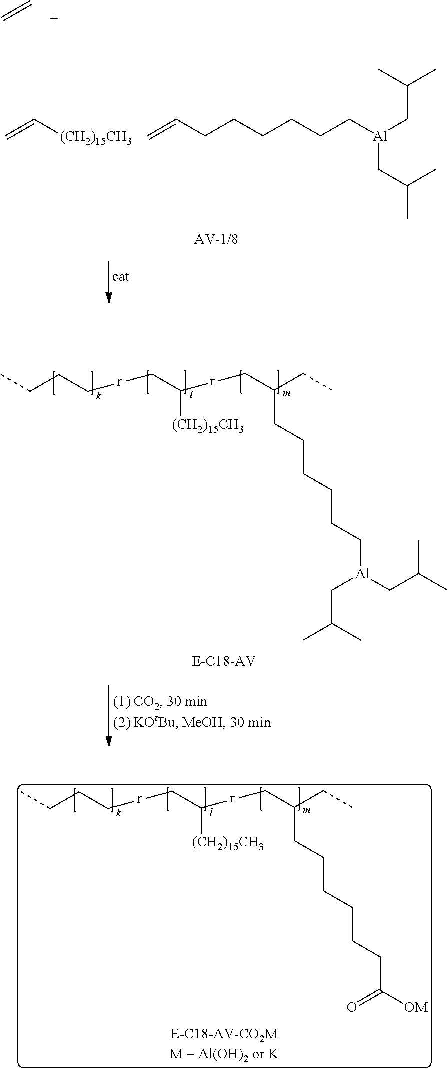

Table 1 shows synthesis conditions of ethylene-propylene-AVTA and ethylene-propylene-AVTA-ENB copolymers prepared via the procedure described above. Table 2 shows values of Mw, Mn, PDI, composition, and glass transition temperature (T_{g}). Values of Mw, Mn, and PDI were determined by GPC-4D (no GPC data on ionomers due to poor solubility). Composition can be measured by NMR (no NMR data on ionomers due to poor solubility). The carboxylate group concentration in the ionomers were determined by FT-IR. Values of T_{g} can be determined by DSC (scanning from −90 to 210° C.; 10° C./min). Results confirm the ability of catalyst 1 to incorporate ethylene, propylene, decene, octadecene, AVTA, and/or ENB in the copolymer.

TABLE 1
Ethylene-propylene-AVTA and ethylene-propylene-
AVTA-ENB synthesis conditions.

| | C₂ | C₃ | ENB | AVTA | decene | octadecene |
|---|---|---|---|---|---|---|
| Sample | (psig) | (mL) | (mL) | (mL) | (mL) | (mL) |
| Control 1 | 100 | 100 | — | — | — | — |
| Example 1 | 100 | 100 | — | 10 | — | — |
| Control 2 | 120 | 75 | — | — | — | — |
| Example 2 | 120 | 75 | — | 3 | — | — |
| Control 3 | 120 | 75 | 10 | — | — | — |
| Example 3 | 120 | 75 | 10 | 3 | — | — |
| Example 4 | 100 | — | — | 3 | 75 | — |
| Example 5 | 120 | — | — | 3 | 75 | — |
| Example 6 | 80 | — | — | 3 | — | 75 |

TABLE 2
Ethylene-propylene-AVTA and ethylene-propylene-AVTA-ENB properties.

| | | | | C₂ | C₃ | ENB | CO₂K | T_{g} | | |
|---|---|---|---|---|---|---|---|---|---|---|
| | M_{w} | Mₙ | PDI | wt % | wt % | wt % | mole % | (° C.) | T_{c} | Tₘ |
| Sample | (g/mol) | (g/mol) | (Mw/Mn) | (NMR) | (NMR) | (NMR) | (FTIR) | (DSC) | (° C.) | (° C.) |
| Control 1 | 100,231 | 30,175 | 3.3 | 28.3% | 71.7% | — | — | −49.3 | | |
| Example 1 | — | — | — | — | — | — | 2.69 | −49.8 | | |
| Control 2 | 284,033 | 101,328 | 2.8 | 53.7% | 46.3% | — | — | −53.0 | | |
| Example 2 | — | — | — | — | — | — | 0.77 | −51.5 | | |
| Control 3 | 233,977 | 61,718 | 3.8 | 52.4% | 36.1% | 11.5% | — | ? | | |
| Example 3 | — | — | — | — | — | — | 0.98 | −41.8 | | |
| Example 4 | — | — | — | — | — | — | 0.15 | −64.6 | 62.3 | 81.1 |
| Example 5 | — | — | — | — | — | — | 0.11 | −66 | 68.3 | 74.9 |
| Example 6 | — | — | — | — | — | — | 0.13 | | T_{c1}: 19.0 | Tₘ₁: 23.56 |
| | | | | | | | | | T_{c2}: 76.5 | Tₘ₂: 91.5 |

### Properties of Ethylene-Propylene-AVTA-K Ionomers

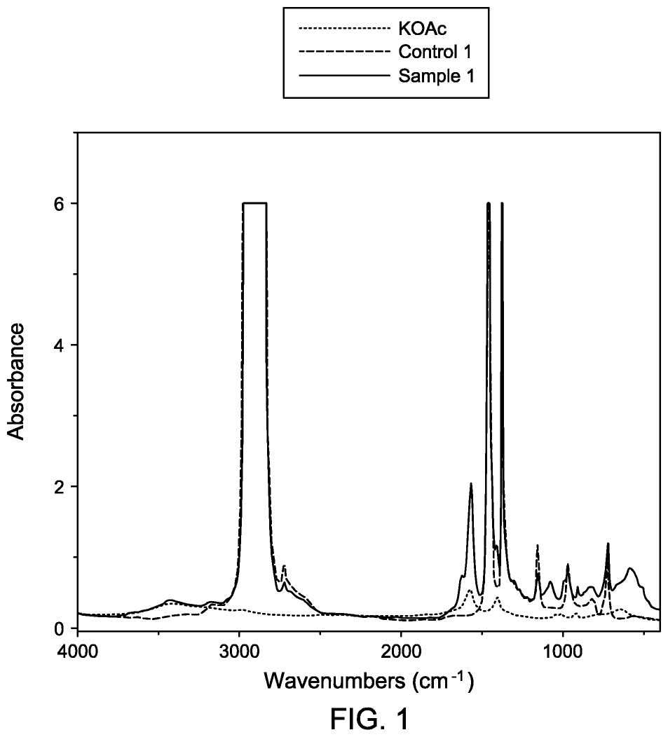

FIG. 1 is a graph illustrating an FTIR analysis comparison between the ethylene-propylene-AV-K ionomer (Example 1), the ethylene-propylene copolymer (Control 1), and a potassium acetate standard, according to at least one embodiment. The FTIR method used to generate this data is described above. Results show that the ethylene-propylene-AVTA-K ionomer and the potassium acetate standard each have an absorbance peak at about 1600 cm⁻¹ indicating presence of carboxylate groups. In contrast, the ethylene-propylene copolymer does not have an absorbance peak at about 1600 cm⁻¹.

Tensile and hysteresis tests on small dog bone specimens of the ethylene-propylene-AVTA-K ionomer (Example 1) and the ethylene-propylene copolymer (Control 1) were performed. Dog bone specimens with dimensions of 5 mm by 5 mm by 0.5 mm were loaded into a RSA-G2 instrument (TA instruments), using clamps for film geometry. The measurements temperature was equilibrated using the forced-convection oven for 5 minutes. After temperature equilibration, the specimens were uniaxially deformed at a rate of 0.1 mm/s. The normal force required for the deformation was measured with the force transducer and converted to engineering stress values by dividing the measured force by the initial cross section are of the dog bones.

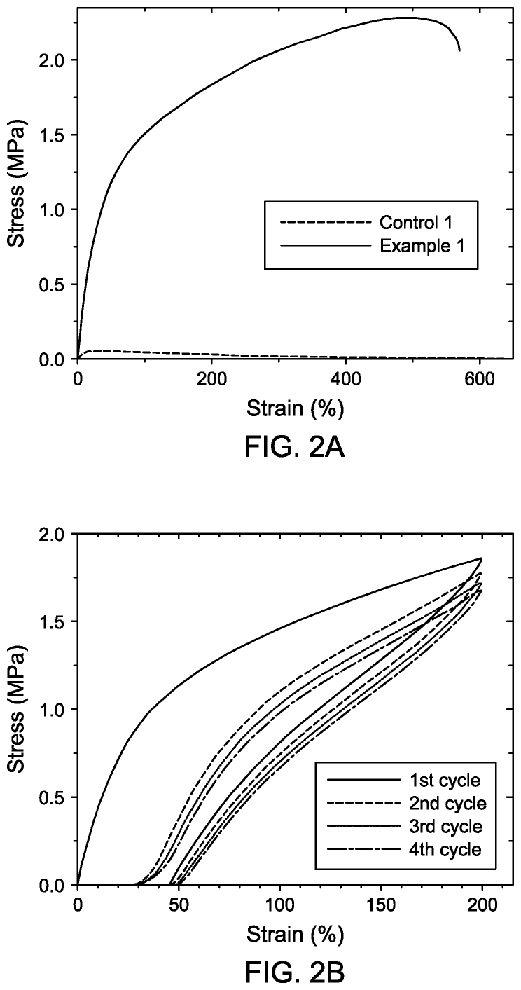

FIG. 2A shows stress-strain curves of the two samples (Example 1 and Control 1) measured at 25° C. Results show that the ethylene-propylene-AVTA-K ionomer (Example 1) can elastically deform. In that regard, the ethylene-propylene-AVTA-K ionomer has a maximum elastic range of about 460% strain, when determined according to ASTM D638. The ethylene-propylene-AVTA-K ionomer has a strain to breakage of about 570%, when determined according to ASTM D638. In contrast, the ethylene-propylene copolymer only plastically deforms. The ethylene-propylene-AVTA-K ionomer has a tensile strength of about 2.5 MPa. The ethylene-propylene-AVTA-K ionomer has a Young's modulus of about 5.6 MPa.

FIG. 2B is a graph illustrating a hysteresis test of the ethylene-propylene-AVTA-K ionomer (Example 1) measured at 25° C., according to at least one embodiment. Results show that the ethylene-propylene-AVTA-K ionomer has a tensile set, at 200% deformation, of about 45%.

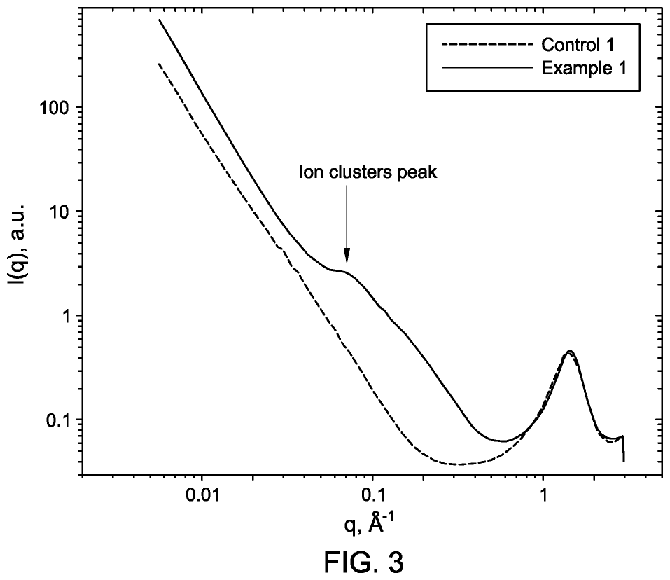

FIG. 3 is a graph illustrating a comparison of scattering data between the ethylene-propylene-AVTA-K ionomer (Example 1) and the ethylene-propylene copolymer (Control 1). Results show that the ethylene-propylene-AVTA-K ionomer has a peak at about 0.07 Å⁻¹, which indicates the presence of ion clusters. Thus, the ion exchange reaction results in formation of an ionomer having local ion clustering. In contrast, the ethylene-propylene copolymer does not have an ion clusters peak.

FIG. 4 shows the DMTA analysis of the ethylene-propylene-AVTA-K ionomer (Example 2) and the ethylene-propylene copolymer (Control 2) experimental samples. Results show the glass transition temperature (measured as the temperature at the peak of E″) of Control 2 and Example 2 are about the same (−53° C. and −51.5° C., respectively). The plot also shows that, above Tg, both samples show an elastic modulus (E′) plateau, indicating the rubbery elasticity response of both samples. However, the elastic modulus drops substantially at T>70° C. for the Control 2, indicating a transition to a liquid like behavior. In the case of Example 2, however, the plateau modulus remained nearly unchanged up to T=200° C., indicating solid like behavior, which is due to the physical crosslinks yielded by the ion clusters.

Overall, polyolefin-based ionomers of the present disclosure have improved mechanical properties, such as increased elasticity and increased strain to breakage, compared with their precursor copolymers without ionic groups. In some aspects polyolefin-based ionomers of the present disclosure have mechanical properties that are comparable to cross-linked rubbers. Polyolefin-based ionomers of the present disclosure can also flow and can be reprocessed in contrast to cross-linked rubbers. In some embodiments, the polyolefin-based ionomers, in contrast to their precursor polymers, can behave similarly to physically cross-linked materials, such as cross-linked rubbers, at room temperature and can be reprocessed into new products at relatively higher temperatures. In some embodiments, the polyolefin-based ionomers can perform as well or better than soft grade ethylene propylene rubbers.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. An ionomer comprising: a copolymer comprising:
C₂-C₆₀ α-olefin monomer units;
optional C₂-C₆₀ α-olefin comonomer units different than the monomer units;
optional diene units, and
about 0.1 wt % to about 20 wt % metal alkenyl units, based on the weight of the copolymer, wherein the metal alkenyl units have the formula —R(A⁻)—, wherein R is an alkyl group containing 2 to 10 carbon atoms, and A⁻ is an anionic group; and
one or more metal cations derived from the group consisting of alkali metals, alkaline earth metals, group 3-12 metals, group 13-16 metals, and combination(s) thereof, wherein the ionomer has a glass transition temperature of −60° C. to 5° C., and a weight average (Mw) of 50 to 5,000 kg/mol.

2. The ionomer of claim 1, wherein the anionic group is selected from the group consisting of a sulfonate, a phosphonate, a carboxylate, and combination(s) thereof.

3. The ionomer of claim 2, wherein the anionic group comprises a carboxylate group.

4. The ionomer of claim 1, wherein the metal cation is an alkali or alkaline earth metal.

5. The ionomer of claim 1, wherein the metal cation comprises Na or Zn.

6. The ionomer of claim 1, wherein the metal cation comprises Zn.

7. The ionomer of claim 1, wherein the ionomer has a tensile strength, at 25° C., of from about 0.1 MPa to about 10 MPa; a Young's modulus, at 40° C. of from about 0.5 MPa to about 10 MPa, and a glass transition temperature of from about −100° C. to about −10° C.

8. A process for making an ionomer, comprising:
providing a copolymer comprising:
C₂-C₆₀ α-olefin monomer units;
optional C₂-C₆₀ α-olefin comonomer units different than the monomer units; optional diene units; and
about 0.1 wt % to about 10 wt % aluminum vinyl (AV) units, based on the weight of the copolymer;
wherein the copolymer has AV units randomly incorporated within the copolymer chain, a glass transition temperature of −30° C. or less, and crystallinity of less than 10%;
introducing an oxidizing agent to the copolymer to form a copolymer comprising anion alkenyl groups; and
introducing a metal cation to the copolymer comprising anion alkenyl groups to form the ionomer, wherein the metal cation is selected from the group consisting of an alkali metal, an alkali earth metal, a group 12 metal, and combination(s) thereof,
wherein the ionomer has a tensile strength of greater than 1 MPa, due to ionomeric physical crosslinks, a glass transition temperature of −30° C. or less, and a crystallinity of less than 10%).

9. The process of claim 8, wherein providing the copolymer comprises:
introducing the C₂-C₆₀ α-olefin and the metal alkenyl to a catalyst system comprising an activator and a catalyst compound; and
forming the copolymer under reaction conditions.

10. The process of claim 8, wherein the oxidizing agent is selected from the group consisting of CO₂, sulfonic acid, acetyl sulfate, phosphonic acid, and combination(s) thereof.

11. The process of claim 10, wherein the CO₂ is introduced at a pressure of from about 50 psi to about 150 psi, wherein introducing the oxidizing agent to the copolymer is performed at a temperature of about 50° C. to about 100° C., and for a time of about 5 minutes to about 30 minutes.

12. The process of claim 9, wherein the activator comprises N,N-Dimethylanilinium tetrakis(pentafluorophenyl)borate.

13. The process of claim 9, wherein the catalyst system comprises:

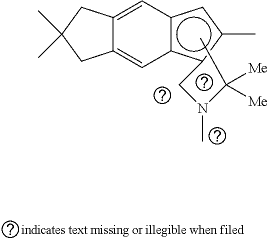

14. The process of claim 8, wherein the aluminum vinyl units have the formula Al(R′)₃₋ᵥ(R)ᵥ, wherein R is a hydrocarbenyl group containing 4 to 12 carbon atoms having a vinyl chain end, wherein R′ is a hydrocarbyl group containing 3 carbon atoms or greater, and wherein v is between 1 and 3.

15. The process of claim 8, wherein the aluminum vinyl comprises di(isobutyl)(7-octen-1-yl)aluminum.

16. The process of claim 8, wherein the diene is present and is selected from the group consisting of vinylnorbornene, norbornadiene, 5-ethylidene-2-norbornene, 5-vinyl-2-norbornene, divinylbenzene, dicyclopentadiene, and combination(s) thereof.

17. The process of claim 9, wherein the catalyst comprises (Me₂Si(η⁵-2,6,6-trimethyl-1,5,6,7-tetrahydro-s-indacen-1-yl)(η¹-N^{t}Bu)TiMe₂) and the activator comprises N,N-dimethylanilinium tetrakis(pentafluorophenyl)borate.
